(19) United States
(12) Patent Application Publication
(10) Pub. No.: US 2025/0270817 A1
(43) Pub. Date: Aug. 28, 2025

(54) HANDLE DEVICES AND RELATED METHODS OF INSTALLATION

(71) Applicant: NuWhirl Systems Corp, Corona, CA (US)

(72) Inventors: Jeff Harlan, Corona, CA (US); Jim Runnion, Corona, CA (US); Robert Goldstein, Corona, CA (US); Bruce Healy, Costa Mesa, CA (US)

(73) Assignee: NuWhirl Systems Corp, Corona, CA (US)

(21) Appl. No.: 19/064,069

(22) Filed: Feb. 26, 2025

Related U.S. Application Data
(60) Provisional application No. 63/557,784, filed on Feb. 26, 2024.

(51) Int. Cl. E04F 11/18; A47K 17/02; F16B 7/04

(52) U.S. Cl. CPC E04F 11/1804; A47K 17/022; F16B 7/04

(57) ABSTRACT

Handle devices are disclosed herein. Modular handle devices have a handle module, at least two connector modules, each individually coupled to respective handle ends via a respective coupler, at least two wall mounts, each extending from corresponding connector modules, and at least two couplers, each coupler spanning from respective ends of the handle module to corresponding connector modules. Fixed, non-modular handle devices are also disclosed herein. Methods for installing handle devices are also disclosed herein.

### CROSS REFERENCE TO RELATED APPLICATIONS

This application claims the benefit of U.S. Provisional Application No. 63/557,784 filed Feb. 26, 2024 and entitled Handle Devices and Related Methods Of Installation, the entirety of which is incorporated herein by reference in its entirety.

### FIELD

The present disclosure relates to handle devices and methods of installation thereof.

### BACKGROUND

Household or other building structure environments can often be hazardous without handle supports being available. For example, bathing environments are often slippery due to wet conditions, which can result in injury of a person. Due to the private nature of household or bathing environments, injuries can become more dangerous than would otherwise be the case because help from individuals is not readily available. This can be especially hazardous for older or disabled users.

This background information is provided for the purpose of making known information believed by the applicant to be of possible relevance to the present disclosure. No admission is necessarily intended, nor should be construed, that any of the preceding information constitutes prior art against the present disclosure.

### SUMMARY

It is desirable to improve the safety in building structures, including household and bathing environments. Handles are common to improve the safety of, for example, bathing environments but handles are not aesthetic and can disrupt the walls of a bathing environment. This disclosure provides modular handle devices that can be customized for different environments or needs, such as on a flat wall or around an outside or inside corner. Handle devices disclosed herein may retain customizable inserts that provide safety or aesthetic benefits.

According to an aspect of the present disclosure there is provided, which may be used alone or in combination with any other aspects described herein a modular handle device comprising:
a handle module comprising:
   a handle body having a first handle end and an opposed second handle end, the first handle end and second handle end each defining a respective handle coupling channel;
   the handle body being configured to be grasped by a user;
at least two connector modules, each individually coupled to respective handle ends via a respective coupler, each connector module comprising:
   a connector body with a first connector face and an opposing second connector face, each connector face spanning between a first connector end and an opposed second connector end;
   the first connector end and the second connector end each defining a connector coupling channel;
   the second connector face defining a wall mount aperture configured to receive a wall mount;
at least two wall mounts, each extending from corresponding connector modules, each wall mount being configured to secure the modular handle device to a surface of a wall, each wall mount comprising:
   a wall plate comprising:
      a wall plate body having a first wall plate face and an opposed second wall plate face, the wall plate body defining two or more wall plate apertures configured to receive corresponding wall mounting fasteners;
      a male part extending from the first wall plate face;
   an extension plate comprising:
      an extension plate body having a first extension plate face and an opposed second extension plate face;
      the second extension plate face defining a chamber configured to receive the wall plate;
      a female part extending from the first extension plate face having an inner chamber configured to mate with the male part of the wall plate; and
at least two couplers, each coupler spanning from respective ends of the handle module to corresponding connector modules, each coupler comprising:
   a coupler body configured to be received in the handle coupling channel; and
   a coupling tab extending from an end of the coupler body, the coupling tab being configured to be received in the connector coupling channel.

In an aspect, an alignment tab is shaped and positioned to be received by a corresponding alignment recess when a handle module and connector module are coupled.

In an aspect, the alignment tab is extending from the first connector end and/or the second connector end, and the alignment recess is defined in the first handle end and/or second handle end.

In an aspect, the first handle end defines at least one alignment recess, the second handle end defines at least one alignment recess, at least one alignment tab extends from the first connector end, and at least one alignment tab extends from the second connector end.

In an aspect, the coupling tab is configured for mating with an adjacent coupling tab.

In an aspect, the coupling tab has one of:
an upper shelf; or
a lower shelf;
wherein the upper shelf and lower shelf are configured to mate with one another.

In an aspect, the upper shelf and lower shelf form a pivot point when mated and connected to one another via a fastener.

In an aspect, the coupler comprises a tongue configured to slidably engage a corresponding groove defined within the handle coupling channel.

In an aspect, an outer surface of the male part of the wall plate and an inner surface of the female part have complementary threading.

In an aspect, the connector body is substantially straight.

In an aspect, the connector body has a bent or elbow configuration.

In an aspect, the connector body has an internal angle of 30°, 60° or 90°.

In an aspect, the connector body comprises a first part and a second part that are pivotably coupled such that an internal angle of the connector body is adjustable.

In an aspect, the connector coupling channel continuously spans from the first connector end to the second connector end.

In an aspect, the handle module defines a recess configured for receiving an insert.

In an aspect, the handle module defines a slot configured to receive and retain a plate within the recess.

In an aspect, the handle device comprises an end cap module comprising:
an abutment member for abutting and capping an end of the modular handle device;
an end cap coupling tab extending from the abutment member, the end cap coupling tab being configured to be received in the connector coupling channel.

In an aspect, the end cap coupling tab is configured for mating with an adjacent coupling tab.

In an aspect, the end cap coupling tab has one of:
an upper shelf; or
a lower shelf;
wherein the upper shelf and lower shelf are configured to mate with one another.

In an aspect, the abutment member defines an alignment recess for receiving an alignment tab.

In an aspect, the modular handle device comprises two handle modules, each coupled to respective connector modules via couplers.

According to another aspect of the present disclosure there is provided, which may be used alone or in combination with any other aspects described herein, a handle module for a modular handle device, the handle module comprising:
a handle body having a first handle end and an opposed second handle end, the first handle end and second handle end each defining a handle coupling channel;
the handle body being configured to be grasped by a user.

In an aspect, the handle module defines a recess configured for receiving an insert.

In an aspect, the handle module defines a slot configured to receive and retain a plate within the recess.

According to another aspect of the present disclosure there is provided, which may be used alone or in combination with any other aspects described herein, a connector module for a modular handle device, the connector module comprising:
a connector body with a first connector face and an opposing second connector face, each connector face spanning between a first connector end and an opposed second connector end;
the first connector end and the second connector end each defining a connector coupling channel;
the second connector face defining a wall mount aperture configured to receive a wall mount.

In an aspect, the connector body is substantially straight.

In an aspect, the connector body has a bent or elbow configuration.

In an aspect, the connector body has an internal angle of 30°, 60°, or 90°.

In an aspect, the connector body comprises a first part and a second part that are pivotable coupled such that an internal angle of the connector body is adjustable.

In an aspect, the connector coupling channel continuously spans from the first connector end to the second connector end.

According to another aspect of the present disclosure there is provided, which may be used alone or in combination with any other aspects described herein, a wall mount for a modular handle device, the wall mount comprising:
a wall plate comprising:
   a wall plate body having a first wall plate face and an opposed second wall plate face, the wall plate body defining two or more wall plate apertures configured to receive corresponding wall mounting fasteners;
   a male part extending from the first wall plate face; and
an extension plate comprising:
   an extension plate body having a first extension plate face and an opposed second extension plate face;
   the second extension plate face defining a chamber configured to receive the wall plate;
   a female part extending from the first extension plate face having an inner chamber configured to mate with the male part of the wall plate; and
the wall mount being configured to secure the modular handle device to a surface of a wall.

In an aspect, an outer surface of the male part of the wall plate and an inner surface of the female part have complementary threading.

According to another aspect of the present disclosure there is provided, which may be used alone or in combination with any other aspects described herein, an end cap module for a modular handle device, the end cap module comprising:
an abutment member for abutting and capping an end of the modular handle device;
an end cap coupling tab extending from the abutment member, the end cap coupling tab being configured to be received in a connector coupling channel.

In an aspect, the end cap coupling tab is configured for mating with an adjacent coupling tab.

In an aspect, the end cap coupling tab has one of:
an upper shelf; or
a lower shelf;
wherein the upper shelf and lower shelf are configured to mate with one another.

In an aspect, the abutment member defines an alignment recess for receiving an alignment tab.

According to another aspect of the present disclosure there is provided, which may be used alone or in combination with any other aspects described herein, a method for installing a modular handle device, the method comprising:
a. coupling a handle module to a first connector module and a second connector module at a first handle end and an opposed second handle end, respectively, via a respective first coupler and a second coupler;
b. securing first and second wall plates to a surface of a wall;
c. mounting first and second extension plates on respective first and second wall plates;
d. securing the first connector module to the first extension plate; and
e. securing the second connector module to the second extension plate.

In an aspect, securing first and second wall plates to the surface of the wall comprises fastening the first and second wall plates to the surface via at least two fasteners per wall plate.

In an aspect, the first and second wall plates are secured to a stud or wood plank installed in the wall.

In an aspect, mounting first and second extension plates comprises fastening each of the first and second extension plates to their respective wall plates via a set screw.

In an aspect, mounting first and second extension plates comprises engaging threading of each of the first and second extension plates with complementary threading of corresponding first and second wall plates.

In an aspect, securing the first connector module comprises securing the first connector module to the first coupler, first extension plate and first wall mount via a fastener.

In an aspect, securing the second connector module comprises securing the second connector module to the second coupler, second extension plate and second wall mount via a fastener.

In an aspect, coupling comprises inserting a coupler body of each of the first coupler and second coupler into respective handle coupling channels, the handle coupling channels separately defined by either the first handle end or second handle end.

In an aspect, coupling comprises inserting respective coupling tabs extending from the coupler body, into respective connector coupling channels defined by respective first and second ends of the connector module.

In an aspect, the method further comprises inserting a handle insert into a recess defined by the handle module.

In an aspect, the method further comprises inserting a connector insert into a recess defined by the connector module.

According to another aspect of the present disclosure there is provided, which may be used alone or in combination with any other aspects described herein, a modular handle device comprising:
a handle module comprising:
   a substantially straight handle body with a first handle face and an opposing second handle face, each handle face spanning between a first handle end and an opposed second handle end,
   a first handle wall and opposing second handle wall spanning between the first handle face and second handle face,
   the first handle end and second handle end each defining a coupling channel;
   the handle body being configured to be grasped by a user;
at least two connector modules, each connector module comprising:
   a connector body with a first connector face and an opposing second connector face, each connector face spanning between a first connector end and an opposed second connector end,
   a first connector wall and opposing second connector wall spanning between the first connector face and second connector face,
   the second connector face defining a wall mount aperture configured to receive a wall mount;
at least two wall mounts, each extending from corresponding connector modules, each wall mount being configured to secure the modular handle device to a surface of a wall, each wall mount comprising:
   a wall plate comprising:
      a substantially flat wall plate body having a first wall plate face and an opposed second wall plate face, the wall plate body defining two or more wall plate apertures configured to receive wall mounting fasteners,
      a male part extending from the first wall plate face;
   an extension plate comprising:
      an extension plate body having a first extension plate face and an opposed second extension plate face;
      the second extension plate face defining a chamber configured to receive the wall plate;
      a female member extending from the first extension plate face configured to mate with the male part of the wall plate; and
at least four couplers, each coupler comprising:
   a coupler body shaped to be received in the coupling channel of the handle module, and
   a coupling part extending from an end of the coupler body, the coupling part being shaped to mate with a complementary shape of an adjacent coupling part.

According to another aspect of the present disclosure there is provided, which may be used alone or in combination with any other aspects described herein, a handle device comprising:
a handle module comprising:
a handle body having a first handle end and an opposed second handle end, the handle body defining a recess for receiving an insert;
the handle body being configured to be grasped by a user;
at least two connector modules connected to respective handle ends, each connector module comprising:
a connector body with a first connector face and an opposing second connector face, each connector face spanning between a first connector end and an opposed second connector end;
the second connector face defining a wall mount aperture configured to receive a wall mount;
at least two wall mounts, each extending from corresponding connector modules, each wall mount being configured to secure the modular handle device to a surface of a wall, each wall mount comprising:
a wall plate comprising:
   a wall plate body having a first wall plate face and an opposed second wall plate face, the wall plate body defining two or more wall plate apertures configured to receive corresponding wall mounting fasteners;
   a male part extending from the first wall plate face;
an extension plate comprising:
   an extension plate body having a first extension plate face and an opposed second extension plate face;
   the second extension plate face defining a chamber configured to receive the wall plate;
   a female part extending from the first extension plate face having an inner chamber configured to mate with the male part of the wall plate; and
an insert.

In an aspect, the handle device comprises at least two couplers, each coupler spanning from respective ends of the handle part to corresponding connector parts, each coupler comprising:
a coupler body configured to be received in handle coupling channel defined in the handle part; and
a coupling tab extending from an end of the coupler body, the coupling tab being configured to be received in a connector coupling channel defined by the connector part.

In an aspect, an alignment tab is shaped and positioned to be received by a corresponding alignment recess when a handle part and connector part are connected, such as via couplers or other fastening process such as bolting or welding.

In an aspect, the alignment tab is extending from the first connector end and/or the second connector end, and the alignment recess is defined in the first handle end and/or second handle end.

In an aspect, the first handle end defines at least one alignment recess, the second handle end defines at least one alignment recess, at least one alignment tab extends from the first connector end, and at least one alignment tab extends from the second connector end.

In an aspect, the coupling tab is configured for mating with an adjacent coupling tab.

In an aspect, the coupling tab has one of:
an upper shelf; or
a lower shelf;
wherein the upper shelf and lower shelf are configured to mate with one another.

In an aspect, the upper shelf and lower shelf form a pivot point when mated and connected to one another via a fastener.

In an aspect, the coupler comprises a tongue configured to slidably engage a corresponding groove defined within the handle coupling channel.

In an aspect, an outer surface of the male part of the wall plate and an inner surface of the female part have complementary threading.

In an aspect, the connector body is substantially straight.

In an aspect, the connector body has a bent or elbow configuration.

In an aspect, the connector body has an internal angle of 30°, 60° or 90°.

In an aspect, the connector body comprises a first part and a second part that are pivotably coupled such that an internal angle of the connector body is adjustable.

In an aspect, the connector coupling channel continuously spans from the first connector end to the second connector end.

In an aspect, the handle part defines a recess configured for receiving an insert.

In an aspect, the handle part defines a slot configured to receive and retain a plate within the recess.

In an aspect, the handle device comprises an end cap module comprising:
an abutment member for abutting and capping an end of the handle device;
an end cap coupling tab extending from the abutment member, the end cap coupling tab being configured to be received in the connector coupling channel.

In an aspect, the end cap coupling tab is configured for mating with an adjacent coupling tab.

In an aspect, the end cap coupling tab has one of:
an upper shelf; or
a lower shelf;
wherein the upper shelf and lower shelf are configured to mate with one another.

In an aspect, the abutment member defines an alignment recess for receiving an alignment tab.

In an aspect, the handle device has two handle parts, each connected, such as via couplers, to respective connector parts.

According to another aspect of the present disclosure there is provided, which may be used alone or in combination with any other aspects described herein, a modular handle device comprising:
a handle module comprising:
   a handle body having a first handle end and an opposed second handle end, the handle body being configured to be grasped by a user;
at least two connector modules, each individually coupled to respective handle ends via a respective coupler, each connector module comprising:
   a connector body with a first connector face and an opposing second connector face, each connector face spanning between a first connector end and an opposed second connector end; and
at least two wall mounts, each extending from corresponding connector modules, each wall mount being configured to secure the modular handle device to a surface of a wall.

In an aspect, the wall mount comprises:
a wall plate comprising:
   a wall plate body having a first wall plate face and an opposed second wall plate face, the wall plate body being configured to secure to a wall;
   a male part extending from the first wall plate face;

In an aspect, the wall mount comprises:
an extension plate comprising:
   an extension plate body having a first extension plate face and an opposed second extension plate face;
   the second extension plate face defining a chamber configured to receive the wall plate; and
   a female part extending from the first extension plate face having an inner chamber configured to mate with the male part of the wall plate.

In an aspect, an outer surface of the male part of the wall plate and an inner surface of the female part have complementary threading.

In an aspect, the second connector face defines a wall mount aperture configured to receive the wall mount.

In an aspect, the modular handle device further comprises an alignment tab shaped and positioned to be received by a corresponding alignment recess when a handle module and connector module are coupled.

In an aspect, the alignment tab is extending from the first connector end and/or the second connector end, and the alignment recess is defined in the first handle end and/or second handle end.

In an aspect, the first handle end defines at least one alignment recess, the second handle end defines at least one alignment recess, at least one alignment tab extends from the first connector end, and at least one alignment tab extends from the second connector end.

In an aspect, the first handle end and second handle end each define a respective handle coupling channel.

In an aspect, the first connector end and the second connector end each define a connector coupling channel.

In an aspect, the connector coupling channel continuously spans from the first connector end to the second connector end.

In an aspect, each coupler comprises:
a coupler body configured to be received in the handle coupling channel; and
a coupling tab extending from an end of the coupler body, the coupling tab being configured to be received in the connector coupling channel.

In an aspect, the coupling tab is configured for mating with an adjacent coupling tab.

In an aspect, the coupling tab has one of:
an upper shelf; or
a lower shelf;
wherein the upper shelf and lower shelf are configured to mate with one another.

In an aspect, the upper shelf and lower shelf form a pivot point when mated and connected to one another via a fastener.

In an aspect, the coupler comprises a tongue configured to slidably engage a corresponding groove defined within the handle coupling channel.

In an aspect, the connector body is substantially straight.

In an aspect, the connector body has a bent or elbow configuration.

In an aspect, the connector body has an internal angle of 60° or 90°.

In an aspect, the connector body comprises a first part and a second part that are pivotably coupled such that an internal angle of the connector body is adjustable.

In an aspect, wherein the handle module defines a recess configured for receiving an insert.

In an aspect, the handle module defines a slot configured to receive and retain a plate within the recess.

In an aspect, the modular handle device further comprises an end cap module comprising:
an abutment member for abutting and capping an end of the modular handle device;
an end cap coupling tab extending from the abutment member, the end cap coupling tab being configured to be received in the connector coupling channel.

In an aspect, the end cap coupling tab is configured for mating with an adjacent coupling tab.

In an aspect, the end cap coupling tab has one of:
an upper shelf; or
a lower shelf;
wherein the upper shelf and lower shelf are configured to mate with one another.

In an aspect, the abutment member defines an alignment recess for receiving an alignment tab.

In an aspect, the modular handle device comprises two handle modules, each coupled to respective connector modules via couplers.

According to another aspect of the present disclosure there is provided, which may be used alone or in combination with any other aspects described herein, a handle device comprising:
a handle part comprising:
   a handle body having a first handle end and an opposed second handle end, the handle body defining a recess for receiving an insert;
   the handle body being configured to be grasped by a user;
at least two connector parts connected to respective handle ends, each connector part comprising:
   a connector body with a first connector face and an opposing second connector face, each connector face spanning between a first connector end and an opposed second connector end; and
at least two wall mounts, each extending from corresponding connector modules, each wall mount being configured to secure the modular handle device to a surface of a wall.

In an aspect, the handle device further comprises an insert configured to be received in the recess of the handle part.

In an aspect, the handle device further comprises an insert within the recess of the handle part.

According to another aspect of the present disclosure there is provided, which may be used alone or in combination with any other aspects described herein, a handle device comprising:
a handle part comprising:
   a handle body having a first handle end and an opposed second handle end;
   the handle body defining a recess for receiving an insert;
   the handle body defining a first and second aperture for receiving a fastener;
   the handle body defining a hollow interior;
   the handle body being configured to be grasped by a user;
first and second wall mounts, each extending from the handle part, each wall mount being configured to secure the handle device to a surface of a wall, each of the first and second wall mounts comprising:
   a wall plate comprising:
      a wall plate body having a first wall plate face and an opposed second wall plate face, the wall plate body being configured to secure to a wall;
      a central aperture defined by the wall plate body and configured to receive a fastener;
   a mounting post extending between and mounted to the handle part and the wall plate, the mounting post defining an inner chamber configured to receive the fastener; and
an end cap part comprising:
   an abutment member for abutting and capping the first or second end of the handle part; and
   an end cap insert extending from the abutment member, the end cap insert being configured to be inserted within the hollow interior of the handle body, the end cap insert being configured for receiving the fastener;
wherein the fastener spans from the central aperture, through the inner chamber of the mounting post to the slot, when assembled.

In an aspect, the handle device further comprises a third wall mount, the third wall mount comprising:
a wall plate comprising:
   a wall plate body having a first wall plate face and an opposed second wall plate face, the wall plate body being configured to secure to a wall;
   a central aperture defined by the wall plate body and configured to receive a fastener;
an extension member extending from, and mounted to, the hollow interior of the handle body, the extension member defining a cavity configured for receiving a fastener;
a mounting post extending between and mounted to the handle part and the wall plate, the mounting post defining an inner chamber configured to receive the fastener and the extension member; and
wherein the fastener spans from the central aperture, through the mounting post, to the cavity of the extension member when assembled.

Other aspects and features of the disclosure will become apparent to those ordinarily skilled in the art upon review of the following description of specific embodiments of the disclosure.

### BRIEF DESCRIPTION OF THE DRAWINGS

Embodiments of the disclosure will now be described in greater detail with reference to the accompanying drawings, in which:

FIG. 1 is a perspective view of a modular handle device;

FIG. 2 is an exploded perspective view of a segment of the modular handle device of FIG. 1;

FIG. 3 is a perspective view of a handle module;

FIG. 4 is an end view of the handle module of FIG. 3;

FIG. 4A is a close-up view of the handle module of FIG. 4;

FIG. 5 is a front elevation view of the handle module of FIG. 3;

FIG. 6 is a rear perspective view of a connector module in a straight configuration;

FIG. 7 is a front perspective view of the connector module of FIG. 6;

FIG. 8 is a front elevation view of the connector module of FIG. 6;

FIG. 9 is an end elevation view of the connector module of FIG. 6;

FIG. 9A is a cross-sectional view along the 9A-9A lines shown in FIG. 9;

FIG. 10 is a rear elevation view of the connector module of FIG. 6;

FIG. 11 is a rear perspective view of a connector module having a bent configuration with a 60° internal angle;

FIG. 12 is a rear plan view of the connector module of FIG. 11;

FIG. 13 is a front plan of the connector module of FIG. 11;

FIG. 14 is a side elevation view of the connector module of FIG. 11;

FIG. 15 is another side elevation view of the connector module of FIG. 11;

FIG. 15A is a cross-sectional view taken along the 15A-15A lines shown in FIG. 15;

FIG. 16 is a rear perspective view of a connector module having a bent configuration with a 90° internal angle;

FIG. 17 is a front perspective view of the connector module of FIG. 16;

FIG. 18 is a rear plan view of the connector module of FIG. 16;

FIG. 19 is a front plan view of the connector module of FIG. 16;

FIG. 20 is a rear elevation view of the connector module of FIG. 16;

FIG. 21 is a side elevation view of the connector module of FIG. 16;

FIG. 21A is cross-sectional view taken along the 21A-21A lines shown in FIG. 21;

FIG. 22 is a perspective view of an adjustable connector module;

FIG. 23 is a front perspective view of a coupler having an upper shelf;

FIG. 24 is a rear perspective view of the coupler of FIG. 23;

FIG. 25 is a rear plan view of the coupler of FIG. 23;

FIG. 25A is a cross-sectional view taken along the 25A-25A lines shown in FIG. 25;

FIG. 25B is a cross-sectional view taken along the 25B-25B lines shown in FIG. 25;

FIG. 25C is a close-up view of the coupler of FIG. 25B;

FIG. 26 is a front elevation view of the coupler of FIG. 23;

FIG. 27 is a top plan view of the coupler of FIG. 23;

FIG. 28 is a rear elevation view of the coupler of FIG. 23;

FIG. 28A is a close-up view of the coupler of FIG. 28;

FIG. 29 is a front perspective view of a coupler having a lower shelf;

FIG. 30 is a rear perspective view of the coupler of FIG. 29;

FIG. 31 is a rear plan view of the coupler of FIG. 29;

FIG. 31A is a cross-sectional view taken along the 31A-31A lines shown in FIG. 29;

FIG. 31B is a cross-sectional view taken along the 25B-25B lines shown in FIG. 29;

FIG. 31C is a close-up view of the coupler of FIG. 31B;

FIG. 32 is a front elevation view of the coupler of FIG. 29;

FIG. 33 is a top plan view of the coupler of FIG. 29;

FIG. 34 is a rear elevation view of the coupler of FIG. 29;

FIG. 34A is a close-up view of the coupler of FIG. 34;

FIG. 35 is a front perspective view of a wall plate;

FIG. 36 is a rear perspective view of the wall plate of FIG. 35;

FIG. 37 is a front elevation view of the wall plate of FIG. 35;

FIG. 37A is a cross-sectional view taken along the 37A-37A line shown in FIG. 37;

FIG. 38 is a side elevation view of the wall plate of FIG. 35;

FIG. 39 is a top perspective view of an extension plate;

FIG. 40 is a rear perspective view of the extension plate of FIG. 39;

FIG. 41 is a side elevation view of the extension plate of FIG. 39;

FIG. 41A is a close-up view of the extension plate of FIG. 41;

FIG. 41B is a cross-sectional view taken along the 41B-41B line shown in FIG. 41;

FIG. 41C is a cross-sectional view taken along the 41C-41C line shown in FIG. 41B;

FIG. 42 is a top plan view of the extension plate of FIG. 39;

FIG. 43 is a front perspective view of a wall plate with a threaded male part;

FIG. 44 is a rear perspective view of the wall plate of FIG. 43;

FIG. 45 is a front elevation view of the wall plate of FIG. 43;

FIG. 45A is a cross-sectional view taken along the 45A-45A line shown in FIG. 45;

FIG. 46 is a side elevation view of the wall plate of FIG. 43;

FIG. 47 is a top perspective view of an extension plate with a threaded female part;

FIG. 48 is a rear perspective view of the extension plate of FIG. 47;

FIG. 49 is a side elevation view of the extension plate of FIG. 47;

FIG. 49A is a cross-sectional view taken along the 49A-49A line shown in FIG. 49;

FIG. 49B is a cross-sectional view taken along the 49B-49B line shown in FIG. 49A;

FIG. 50 is a top plan view of the extension plate of FIG. 47;

FIG. 51 is a rear perspective view of an end cap having a lower shelf;

FIG. 52 is a front perspective view of the end cap of FIG. 51;

FIG. 53 is a rear end view of the end cap of FIG. 51;

FIG. 54 is a top plan view of the end cap of FIG. 51;

FIG. 54A is a cross-sectional view taken along the 54A-54A line shown in FIG. 54;

FIG. 55 is a front end view of the end cap of FIG. 51;

FIG. 55A is a cross-sectional view taken along the 55A-55A line shown in FIG. 55;

FIG. 56 is a bottom plan view of the end cap of FIG. 51;

FIG. 57 is a rear perspective view of an end cap having an upper shelf;

FIG. 58 is a front perspective view of the end cap of FIG. 57;

FIG. 59 is a rear end view of the end cap of FIG. 57;

FIG. 60 is a top plan view of the end cap of FIG. 57;

FIG. 60A is a cross-sectional view taken along the 60A-60A line shown in FIG. 60;

FIG. 61 is a front end view of the end cap of FIG. 57;

FIG. 61A is a cross-sectional view taken along the 61A-61A line shown in FIG. 61;

FIG. 62 is a bottom plan view of the end cap of FIG. 57;

FIG. 63 is a picture depicting a series of embodiments of an end cap;

FIG. 64 is a front perspective view of a plate;

FIG. 65 is an end view of the plate of FIG. 64;

FIG. 66 is a front elevation view of the plate of FIG. 64;

FIG. 67 is a top plan view of an insert for a straight connector module;

FIG. 68 is a top perspective view of the insert of FIG. 67;

FIG. 69 is an end view of the insert of FIG. 67;

FIG. 70 is a front elevation view of the insert of FIG. 67;

FIG. 70A is a cross-sectional view taken along the 70A-70A line shown in FIG. 70;

FIG. 71 is a front perspective view of the insert of FIG. 67;

FIG. 72 is a rear elevation view of an insert for a connector module having an internal angle of 30°;

FIG. 73 is a front perspective view of the insert of FIG. 72;

FIG. 74 is an end perspective view of the insert of FIG. 72;

FIG. 75 is a rear elevation view of the insert of FIG. 72;

FIG. 76 is a top plan view of the insert of FIG. 72;

FIG. 76A is a cross-sectional view taken along the 76A-76A line shown in FIG. 76;

FIG. 77 is an alternative rear elevation view of the insert of FIG. 72;

FIG. 78 is a front elevation view of an insert for a connector module having an internal angle of 90°;

FIG. 79 is a rear perspective view of the insert of FIG. 78;

FIG. 80 is an end view of the insert of FIG. 78;

FIG. 81 is a top plan view of the insert of FIG. 78;

FIG. 81A is a cross-sectional view taken along the 81A-81A line shown in FIG. 81;

FIG. 82 is a side perspective view of the insert of FIG. 78;

FIG. 83 is a perspective view of an insert for a handle module;

FIG. 84 is a top plan view of the insert of FIG. 83;

FIG. 85 is an end view of the insert of FIG. 83;

FIG. 86 is a side elevation view of the insert of FIG. 83;

FIG. 86A is a cross-sectional view taken along the 86A-86A line shown in FIG. 86;

FIGS. 87A-N depict steps of a method of installing a modular handle device;

FIG. 88 is a perspective view of a fixed, non-modular handle device;

FIG. 89 is an end view of the handle device of FIG. 88;

FIG. 90 is a side elevation view of the hand device of FIG. 88, depicted with a partial cross-section taken along a central longitudinal axis and with variable length;

FIG. 91 is a bottom plan view of the handle device of FIG. 90;

FIG. 92 is a bottom plan view of a wall plate;

FIG. 92A is a cross-sectional view taken along the 92A-92A lines of FIG. 92;

FIG. 93 is a top plan view of the wall plate of FIG. 92 with a mounting post and inner cover;

FIG. 93A is a cross-sectional view taken along the 93A-93A lines in FIG. 93;

FIG. 94 is a top plan view of the inner cover of FIG. 93;

FIG. 94A is a cross-sectional view taken along the 94A-94A lines in FIG. 94;

FIG. 95 is a side elevation view of the mounting post of FIG. 93;

FIG. 96 is a top plan view of the mounting post of FIG. 93;

FIG. 97 is a top plan view of the outer cover of FIG. 88;

FIG. 97A is a cross-sectional view taken along the 97A-97A lines in FIG. 97;

FIG. 98 is a bottom plan view of the handle part of the handle device of FIG. 88;

FIG. 99 is a side elevation view of the handle part of FIG. 98;

FIGS. 100 and 101 are perspective views of embodiments of an end cap part;

FIG. 102 is a side elevation view of the end cap part of FIG. 101 without a nut;

FIG. 102A is a cross-sectional view taken along the 102A-102A lines in FIG. 102;

FIG. 103 is a bottom plan view of the end cap part of FIG. 102;

FIG. 104 is a perspective view of a handle device having three wall mounts;

FIG. 105 is an end elevation view of the handle device of FIG. 104;

FIG. 106 is a side elevation view of the handle device of FIG. 104, depicted with indeterminate length and a partial cross-section taken along a central longitudinal axis;

FIG. 107 is a bottom plan view of the handle device of FIG. 104;

FIG. 108 is a side elevation view of the handle part and the mounting post of FIG. 104, depicted with a partial cross-section taken along a central longitudinal axis;

FIG. 109 is a side elevation view of the handle part and mounting post of FIG. 108;

FIG. 110 is a side elevation view of the handle part of FIG. 109;

FIG. 111 is an end elevation view of the handle part of FIG. 110;

FIG. 112 is a top plan view of the mounting post of FIG. 104; and

FIG. 112A is a cross-sectional view taken along the 112A-112A lines in FIG. 112.

### DETAILED DESCRIPTION

One or more illustrative embodiments have been described by way of example. Described herein are modular handle devices and methods of installation thereof. It will be appreciated that embodiments and examples are provided for illustrative purposes intended for those skilled in the art, and are not meant to be limiting in any way. All references to embodiments, examples, aspects, kits and the like is intended to be illustrative and non-limiting.

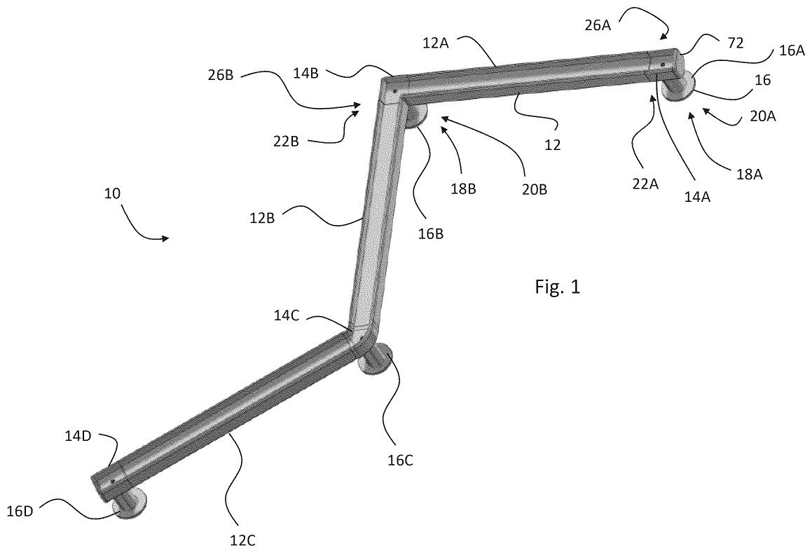

Referring to FIG. 1, modular handle devices 10 comprise a handle module 12 with a handle body 13 having a first handle end 24A and an opposed second handle end 24B, the handle body being configured to be grasped by a user, at least two connector modules 14 (14A, 14B), each individually coupled to respective handle ends 24A, 24B via a respective coupler 22A, 22B, each connector module 14 having a connector body 50 with a first connector face 52A and an opposing second connector face 52B, each connector face spanning between a first connector end 54A and an opposed second connector end 54B; and at least two wall mounts 16 (16A, 16B) each extending from corresponding connector modules 14A, 14B, each wall mount being configured to secure the modular handle device 10 to a surface of a wall.

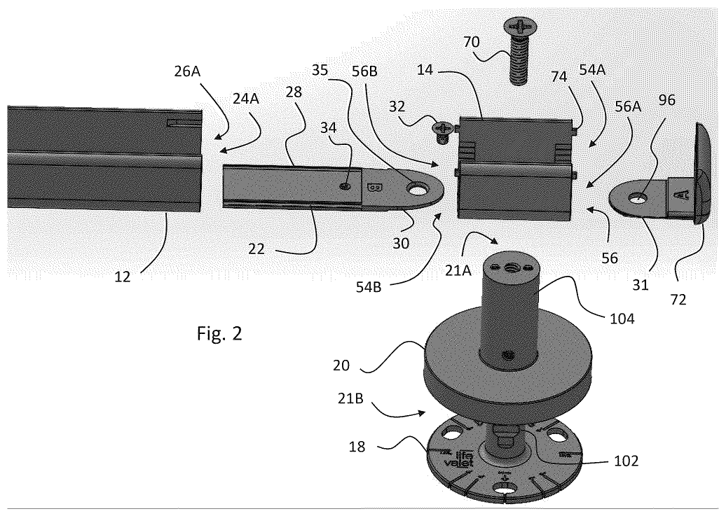

Referring to FIGS. 1 and 2, modular handle devices 10 are disclosed herein having a handle module 12, at least two connector modules 14, such as 14A and 14B, coupled to ends of the handle module 12, at least two wall mounts 16, such as wall mount 16A and 16B, secured to respective connector modules 14A and 14B, and at least two couplers 22 (FIG. 2), each coupler spanning from respective ends of handle module 12 to corresponding connector modules 14A, 14B. Although FIG. 1 depicts a modular handle device 10 having three handle modules (12A, 12B, 12C), four connector modules (14A, 14B, 14C, 14D), and four wall mounts (16A, 16B, 16C, 16D), it will be understood that many combinations of modules are possible. As will be apparent in the following disclosure, modular handle device 10 and associated modules are configured such that they can be coupled into many different combinations to suit a user's needs.

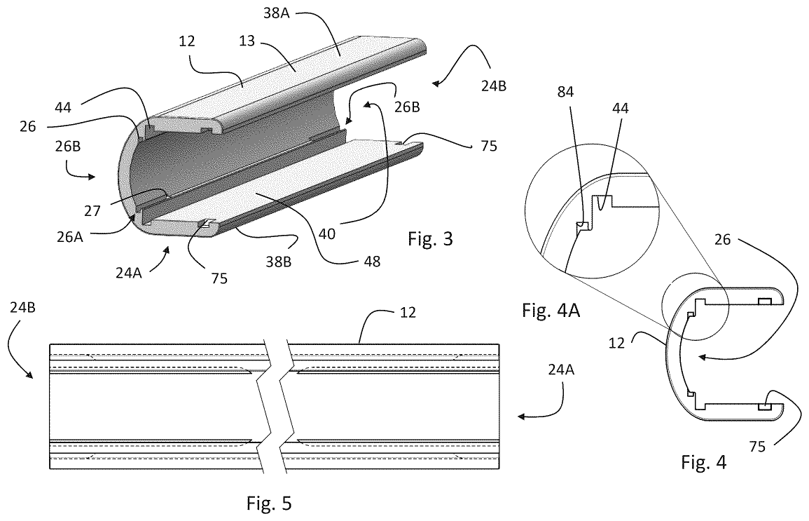

Referring to FIGS. 3-5, handle module 12 is configured to be grasped by a user. Handle module 12 has a handle body 13 having a first handle end 24A and an opposed second handle end 24B, first and second handle ends 24A and 24B each defining a respective handle coupling channel 26A and 26B. The handle body 13 may also have a first handle face 36A and an opposing second handle face 36B, each handle face spanning between first handle end 24A and second handle end 24B. Handle body 13 may have a first handle wall 38A and an opposing second handle wall 38B running between first handle face 36A and second handle face 36B. In some embodiments, the handle module 12 has a bent or curved configuration. For example, handle module 12 may have an L-shape or U-shape. In such cases, the handle module 12 may wrap or traverse around one or more corners of a wall.

The respective coupling channels 26A, 26B may be shaped to receive a part of the coupler 22, such as a coupler body 28. Channels 26A and 26B may receive and retain/grip the coupler 22 through suitable means, such as friction fit. A fastener may be used to secure coupler 22 to handle 12, such as fastener 32 through an aperture 34 defined in coupler body 28 and an aperture 36 defined in handle body 13. Apertures 34 and 36 may be aligned when the coupler body is inserted into a coupling channel 26. When the apertures are aligned, a single fastener, such as fastener 32, may be used. In some cases, a fastener is installed laterally along coupler body 28 into handle body 13. Plural fasteners may also be used to secure coupler 22 to handle part 12. Other fastening means known in the art may be used, such as adhesive or others.

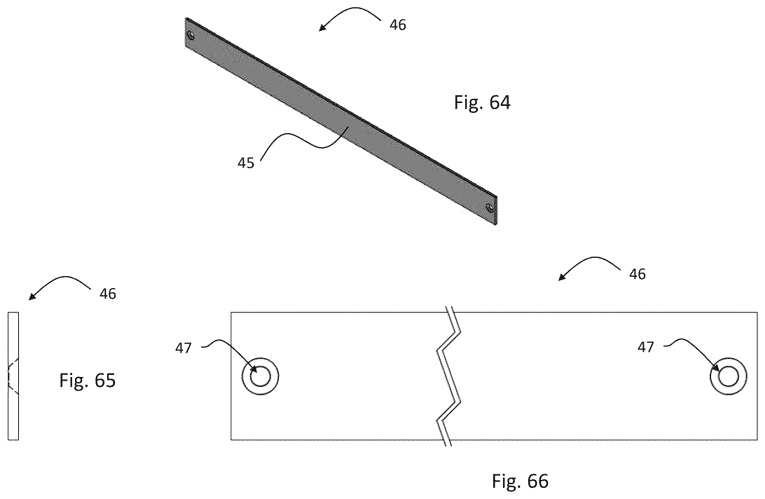

Referring to FIGS. 1-5, handle module 10 defines a recess 40 that configured for receiving an insert 42. Recess 40 may run substantially along a length of handle module 10. Recess 40 may be defined in first handle face 36A. In some cases, handle module 12 comprises retaining members for retaining insert 42. For example, an inner surface 48 may define teeth biased to grip insert 42 when inserted into recess 40. Recess 40 may be sufficiently deep such that the handle module defines a substantially U shape in cross-section (FIG. 4). Handle module 10 may define a slot 44 for receiving a plate 46 (FIGS. 64-66). In some cases, channel 26 is formed at least partially by plate 46 when inserted into slot 44.

Referring to FIG. 3, second face 36B of handle module 12 has a suitable configuration. As shown in FIG. 3, second face 36B may have an arcuate shape in cross-section. Other shapes and configurations may be used, such as a straight shape in cross section.

The length of handle module 10 may be varied within handle device 10. For example, handle device 10 may have several handle modules 10 with equal or non-equal lengths.

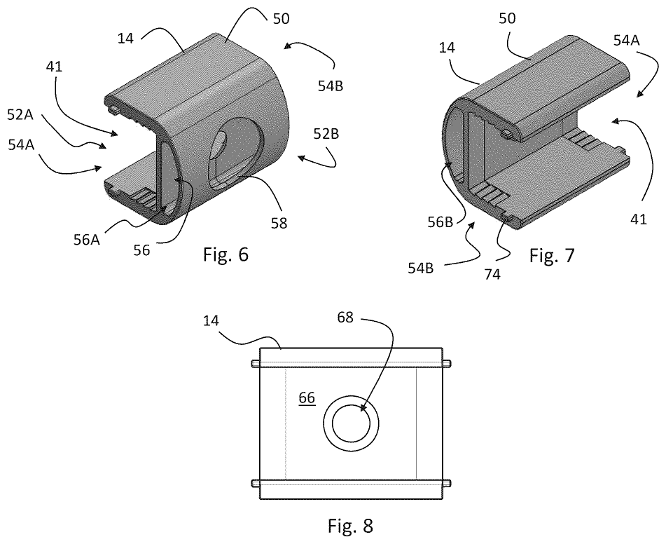

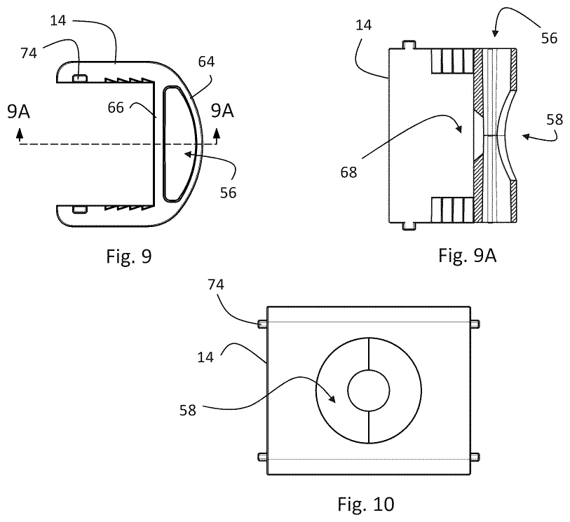

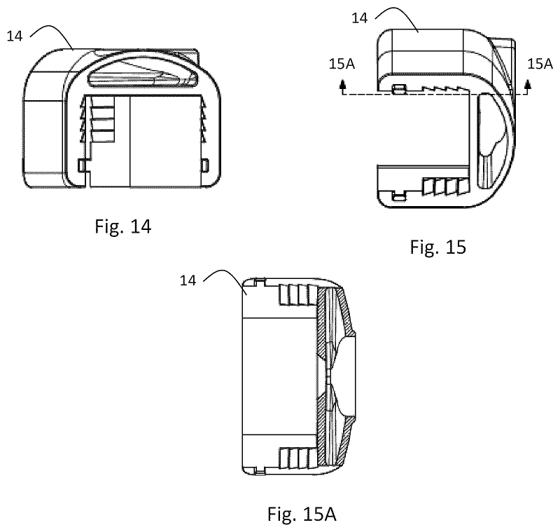

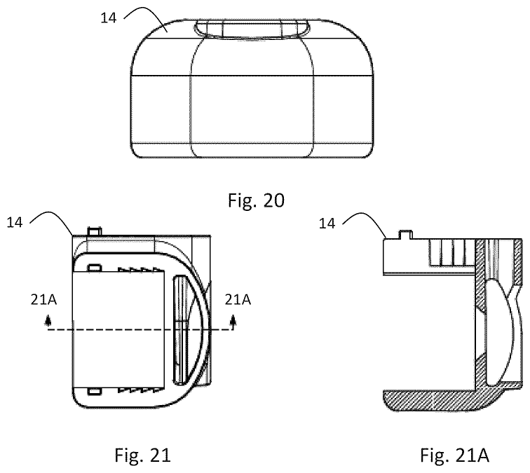

Referring to FIGS. 6-22, connector modules 14 for modular handle device 10 are disclosed herein. Connector module 14 connects to and end of handle module 12 and provides an anchor point for securing handle module 12 to a wall via wall mount 16 (FIG. 2). Connector module 14 has a connector body 50 with a first connector face 52A and an opposing second connector face 52B, each connector face spanning between a first connector end 54A and an opposed second connector end 54B. First connector end 54A and second connector end 54B each define a respective connector coupling channel 56A, 56B for receiving a coupler tab 30. Connector coupling channel 56, such as 56A or 56B, may continuously spans from first connector end 54A to the second connector end 54B.

Referring to FIGS. 6-22, second connector face 52B defines a wall mount aperture 58 configured to receive a wall mount 16. For example, aperture 58 may be shaped to receive a first end 21A of extension plate 20. Aperture 58 may be defined by an outer wall 64 of connector body 50. An inner wall 66 may define an aperture 68 for receiving a fastener 70. A single fastener 70 may be used to secure connector module 14, one or more couplers 22 and/or end caps 72, and wall mount 16. (FIG. 2).

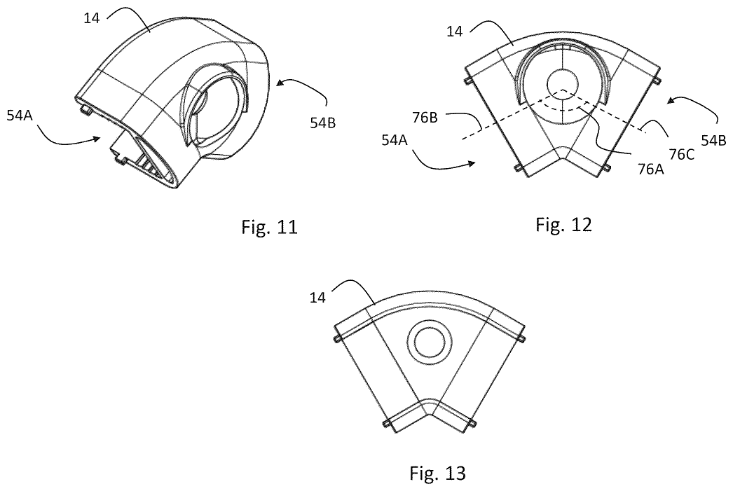

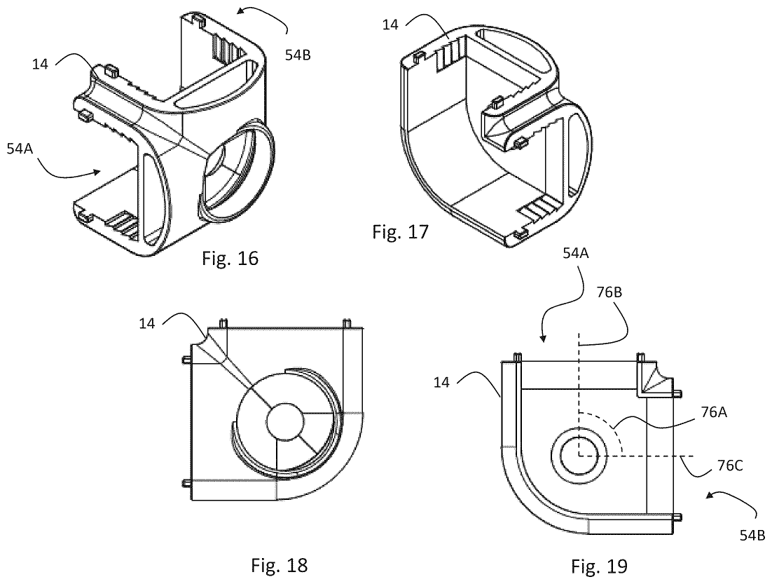

Referring to FIGS. 6-22, connector module 14 has a body 50 with a suitable configuration. For example, connector body 50 may be substantially straight (FIGS. 6-10) or have a bent or elbow configuration (FIGS. 11-21). Connector body may have an internal angle 76A at an intersection of central end axes 76B and 76C (FIGS. 12 and 19). In straight configurations, the internal angle is approximately 180°. In bent or elbow configurations, connector body 50 has an internal angle of approximately 20°-90° or greater. For example, connector body 50 may have a bent configuration having internal angle 76A of 60° (FIG. 12) or 90° (FIG. 19). Referring to FIGS. 11-15, connector body 50 has an internal angle of approximately 30°. Referring to FIGS. 16-21, connector body 50 has an internal angle of approximately 90°.

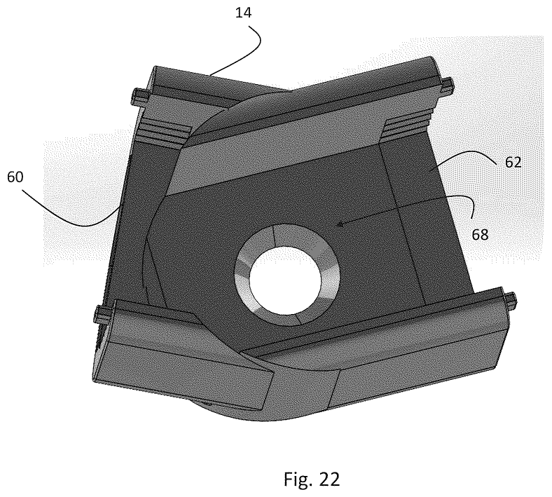

Referring to FIG. 22, connector module 14 may have a body 50 that has an adjustable internal angle. For example, connector body may comprise a first part 60 and a second part 62 that are pivotably coupled such that an internal angle of the connector body 50 is adjustable. Couplers 22 may pivot with the pivotable body 50 in use. For example, when coupling tabs 30 are inserted into a substantially continuous connector channel 56, they may overlap and be configured to pivot within the channel 56. The overlapping coupling tabs 30 may be secured together to form a pivot point, such as by a suitable fastener. As described further below, coupling tabs 30 of adjacent couplers 22 may be configured to mate or otherwise overlap with each other. When adjacent couplers 22 are pivotably connected, such as by a fastener, they may pivot with the pivotable body 50 of connector module 14. First part 60, second part 62 and adjacent couplers 22 may be pivotably connected by a single fastener through suitable apertures.

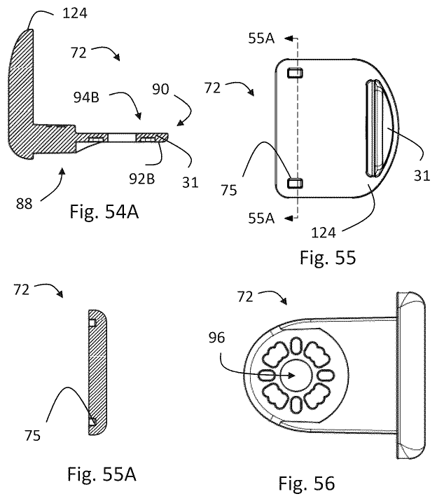

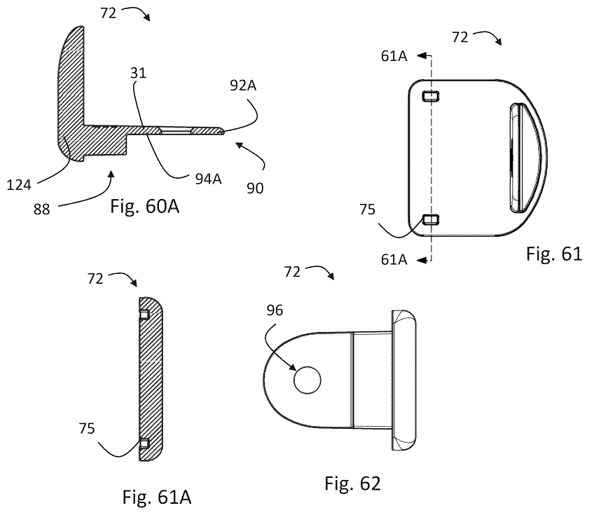

Referring to FIGS. 5-22 and 52-61A, modules of handle device 10 may have an alignment tab 74 configured to be received in an alignment recess 75 in an adjacent module when abutted. Alignment tabs 74 and alignment recesses 75 may be shaped and aligned such that an alignment tab 74 of one module, such as alignment tab 74 of connector module 14, engages and abuts recess 75 of an adjacent module, such as handle module 12 or end cap 72. Alignment tab 74 may extend from first connector end 54A and/or second connector end 54B. In some embodiments, each end 54A, 54B of connector module 14 has plural alignment tabs 74, such as two alignment tabs. Alignment recess 75 may be defined in one or more of first handle end 24A, second handle end 24B or end cap 72. Alignment recess 75 may be defined by one or more of first handle end 24A, second handle end 24B or end cap 74. In some embodiments, each end 24A, 24B defines plural recesses 75, such as two recesses.

Although the Figures depict tabs 74 mounted on connector module 14 and alignment recesses 75 defined by handle module 12, the tabs 74 may be mounted on or extended from handle module 12 or end cap 72 and the recesses 75 may be defined by connector module 14. Alignment tabs 74 and recesses 75 may assist an installer with proper alignment during installation and may assist in providing a substantially flush transition between adjacent modules. Alignment tabs 74 and recesses 75 may also strengthen modular bar 10 when stress is applied, such as tortional stress.

Alignment tabs 74 and complementary alignment recess 75 may have various configurations. Although teeth-like configurations are depicted in the Figures, various configurations may be used without departing from the disclosure. Recess 75 may have a complementary shape to receive alignment tab 74 of an adjacent module.

Referring to FIG. 2, coupler 22 is configured for insertion into adjacent modules such that the adjacent modules are connected and coupled. Once fully inserted, coupler 22 spans an end, such as 24A or 24B, of handle module 12 and corresponding end, such as 54A or 54B, of connector modules 14.

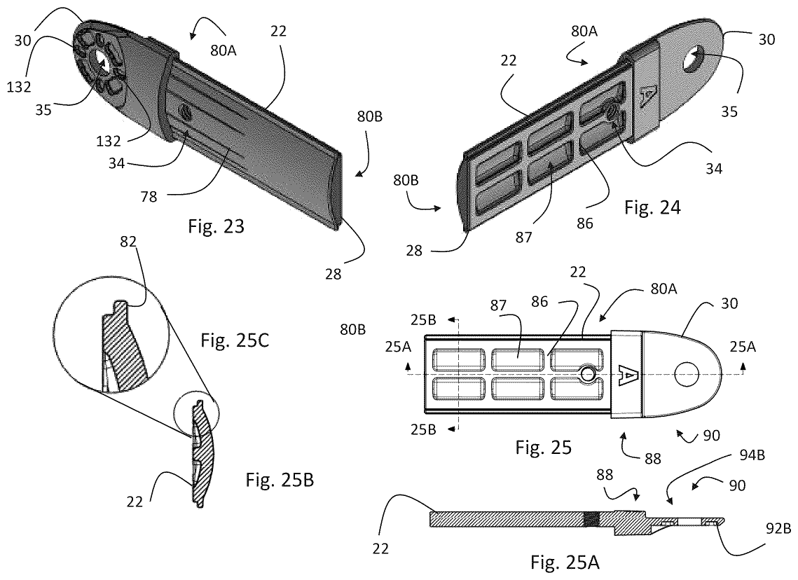

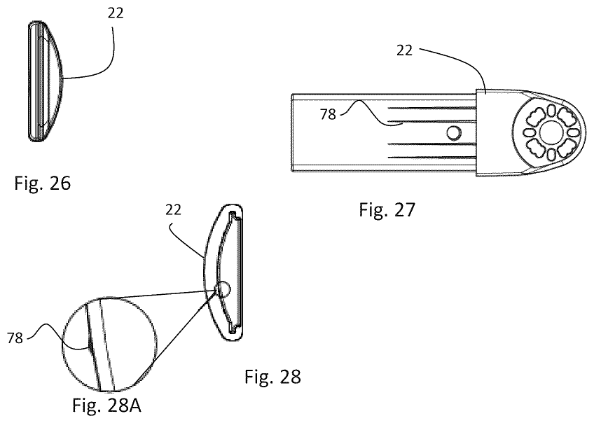

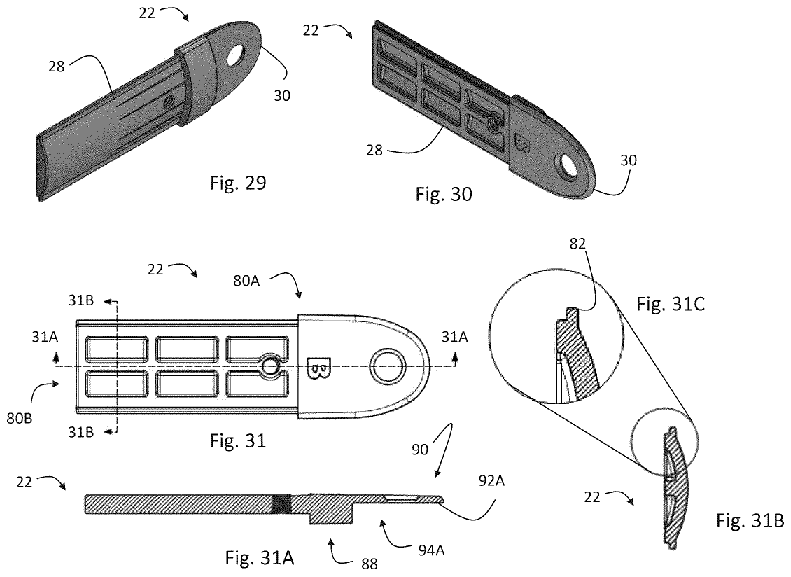

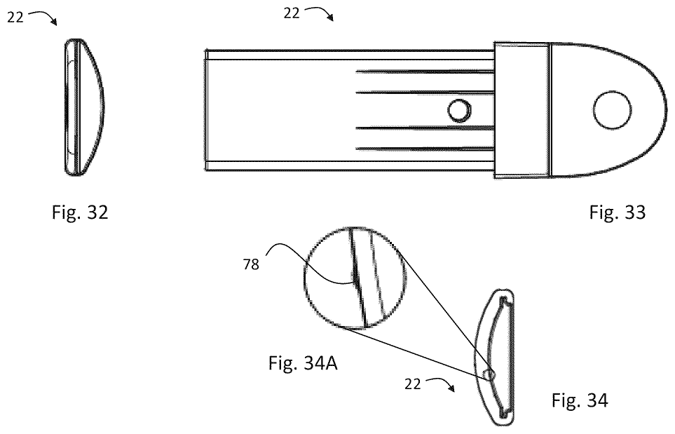

Referring to FIGS. 23-34, coupler 22 has a coupler body 28 and coupler tab 30, extending from coupler body 28. Coupler body 28 is configured to be received in a handle coupling channel 26, such as 26A or 26B. Coupler body 28 may be configured to be received in handle coupling channel 26. In some cases, coupler body 28 may be shaped to friction fit within channel 26, such as by having one or more crush ribs 78. Coupler body 28 may define an aperture for receiving a fastener, such as fastener 32, to fasten coupler 22 to handle 12. Other methods of fastening may be used, such as adhesive. Coupler body 28 may have a first end 80A and an opposed second end 80B. Second end 80B may abut against an inner surface 27 of channel 26 when coupler 22 is inserted. Referring to FIGS. 25B and 25C, coupler body 28 may have a tongue 82 for slidably engaging a corresponding groove 84 defined within channel 26 of handle module 12 (FIGS. 3). Coupler body 28 may comprise structural ribs 86 that may reinforce coupler body 28 while defining one or more gaps 87 to allow for compression during fitting. Coupler body 28 may have a width that is less than a width of coupler tab 30. Having a smaller width may provide a directionality to coupler 22, such that coupler tab 30 is too wide to be received within handle coupler channel 26.

Referring to FIGS. 23-34, coupling tab 30 is configured to be received in connector coupling channel 56. Coupling tab 30 may extend from first end 80A of coupler body 28. Coupler tab 30 may define a fitting portion 88 shaped and configured to be received in connector coupling channel 56. The fitting portion 88 may be retained within channel 56 by a suitable mechanism, such as friction fitting, adhesive or others known in the art.

Referring to FIGS. 23-34, coupling tab 30 is configured for mating with an adjacent coupling tab 30. Coupling tab 30 may define a mating portion 90 shaped and configured to mate with a complementarily shaped coupling tab 30, such as a mating portion 90. Examples of complementary mating portions are provided in FIGS. 25, 25A, 31, and 31A. Coupling tab 30, and mating portion 90, may have one of an upper shelf 92A (FIGS. 31, 31A) or a lower shelf 92B (FIGS. 25, 25A). Upper shelf 92A and lower shelf 92B may be configured to mate with one another. For example, a contact surface 94A of upper shelf 92A may abut with a contact surface 94B of lower shelf 92B when adjacent, complementary couplers 22 are mated. Mating portions 90 of coupler 22 may define an aperture 35 for receiving a fastener, such as fastener 70 (FIG. 2). Apertures 35 of adjacent and complimentary couplers 22 may align in use, such as when received in opposing coupler channels 56. When apertures 35 are aligned, a single fastener may be used to secure couplers 22 to connector module 14 and/or wall mount 16. In cases where an end cap 72 is coupled to connector module 14, such as depicted in FIG. 2, aperture 35 may align with an aperture 96 of the end cap and both can be fastened by a single fastener, such as fastener 70.

Upper shelf 92A and lower shelf 92B of adjacent complementary couplers 22 may form a pivot point when mated and connected to one another via a fastener. When complementary couplers 22 are mated in channels 56 of connector module having adjustable first part 60 and second part 62 (FIG. 22), the couplers may pivot on the same pivot point as first and second parts 60 and 62. This may allow an installer to adjust connecting angles of the modular handle device after each module has been coupled.

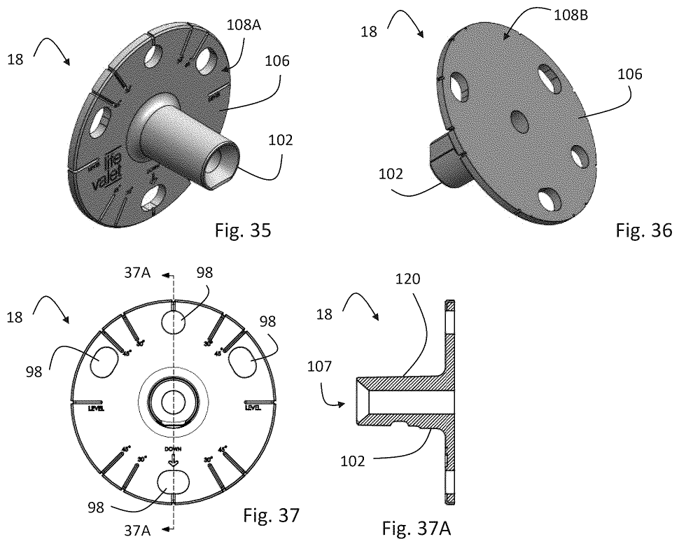

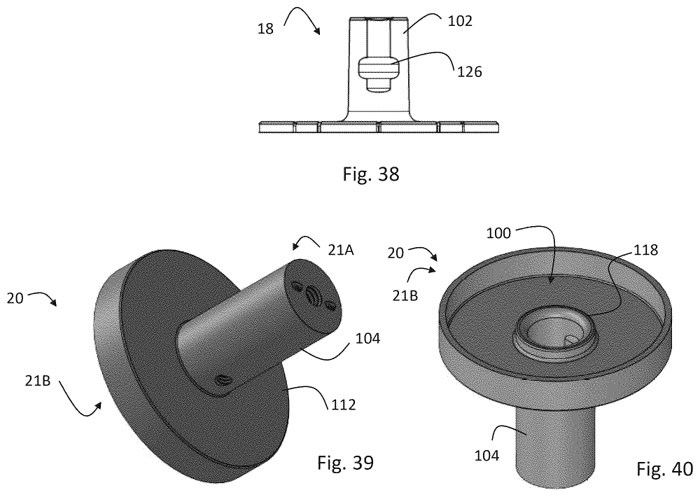

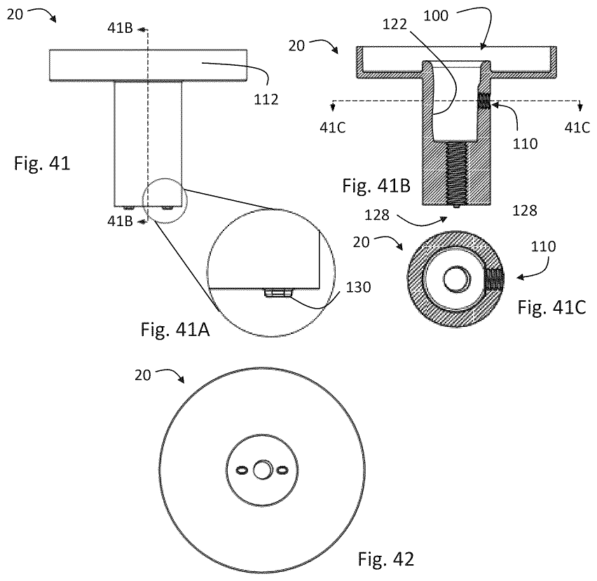

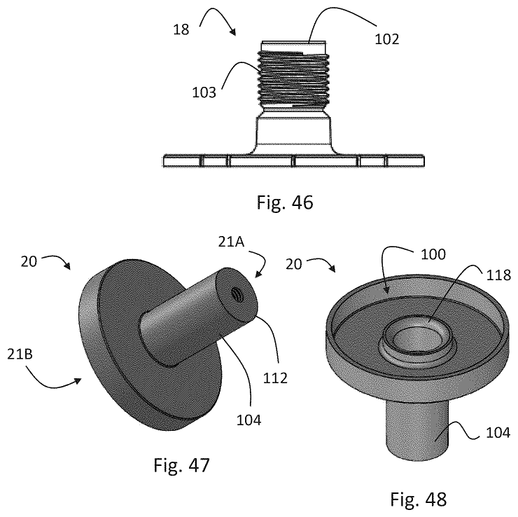

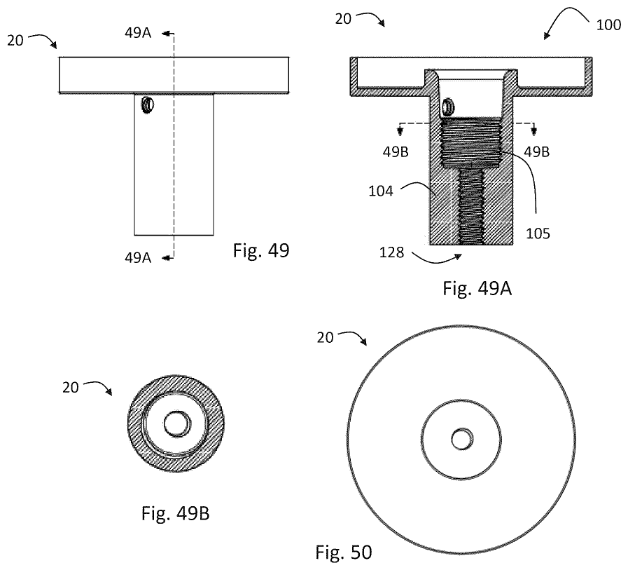

Referring to FIGS. 35-50, wall mounts 16 for securing handle device 10 to the wall are shown. Wall mount 16 comprises a wall plate 18 and an extension plate 20. Wall mount 16 is secured to the wall using a suitable mechanism, such as two or more fasteners through apertures 98. After wall plate 18 has been secured to the wall, extension plate 20 is secured or nested to wall plate 18, such as by placing plate 18 into an extension plate chamber 100 defined in second end 21B. The extension plate is then secured to the handle device 10, such as by engaging one or more part of first end 21A, such as a post or female part 104 with connector module 14. For example, connector module 14 may define wall mount aperture 58 in outer wall 66 configured to receive female part 104, which can then be fastener by a suitable fastener, such as a set screw through aperture 110 (FIG. 41B). Wall plate 18 and extension plate 20 may have an enlarged footprint to assist in distributing force applied to the bar across a larger area of the wall. Distributing the force over a larger area may allow the bar to handle larger amounts of force, such as downward force applied by a user, without failure or otherwise damage to the wall.

Referring to FIGS. 35-38 and 43-46, wall plate 18 comprises a wall plate body 106 having a first wall plate face 108A and an opposed second wall plate face 108B. Wall plate body 106 defines two or more wall plate apertures 98 configured to receive corresponding wall mounting fasteners. Wall plate body 106 also has male part 102 extending from first wall plate face 108A. Wall plate body 18 may be shaped to be received in complementarily shaped chamber 100 of extension plate 20. Male part 102 may define an aperture 107 for receiving a fastener. Although the Figures depict an approximately circular shape for body 106, other shapes and configurations may be used. The spacing of apertures 98 may be adjusted. Male part 102 may also define a gripping portion 126 for receiving a fastener, such as a set screw, through an aligned aperture 110 of female part 104 when nested. Referring to FIGS. 39-42 and 47-50, extension plate 20 has an extension plate body 112 having first extension plate face 21A and opposed second extension plate face 21B. Second extension plate face 21B defines chamber 100 configured to receive wall plate 18. Female part 104 extends from first extension plate face 21A and defines an inner chamber 114 configured to mate with male part 102. Chamber 100 may comprise structural ribs 116 to reinforce and strengthen extension plate 20. Female part 104 may define an aperture 110 for receiving a fastener, such as a set screw to secure extension plate 20 to wall plate 18. Female part 104 may define an aperture 128 for receiving a fastener, such as bolt 70, to secure extension plate 20 to one or more of wall plate 18, connector module 14, coupler 22, and end cap 72. Chamber 100 may comprise a lip 118 that is configured to engage with wall plate 18, such as first wall plate face 108A, when nested. Extension plate body 112 may have one or more guide pins 130 (FIGS. 41 and 41A) shaped and configured to engage recesses 132 of coupler 22. During installation, after coupler 22 has been inserted into connector 14, wall mount 16 may be inserted into aperture 58, with guide pins 130 engaging with recesses 132 (FIG. 23). The extension plate 20 may then be secured to the connector module 14 via a suitable fastener.

In some cases, extension plate 20 is a post that nests in a recess defined by wall plate 18 (not pictured). Such posts may be secured or fastened to connector module 14. The post would be secured to wall plate 18 by a fastener through the post into wall plate 18.

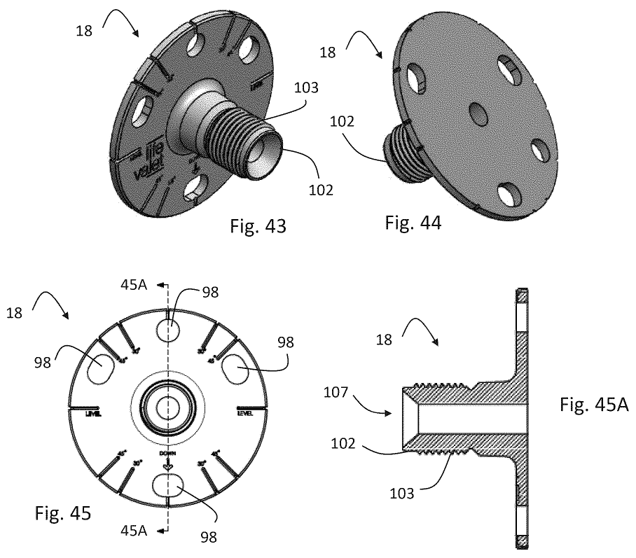

Referring to FIGS. 43-50, wall plate 18 and extension plate 20 may have complementary threading. For example, an outer surface 120 of male part 102 has male threading 103 (otherwise known as pin threading) and an inner surface 122 of female part 104 has female threading 105 (otherwise known as box threading).

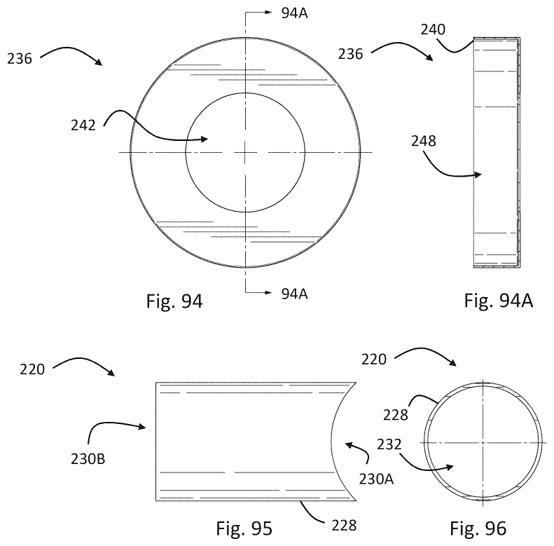

Referring to FIGS. 90-96, embodiments of wall mount 216 are depicted for mounting handle part 202 to a wall. Each of wall mounts 216, such as first and second wall mounts 216A and 216B, are comprised of wall plate 218 and mounting post 220. A person of skill in the art would understand that wall mounts 16 or 216 could be used with modular or non-modular handle devices as taught herein, with or without minor modifications.

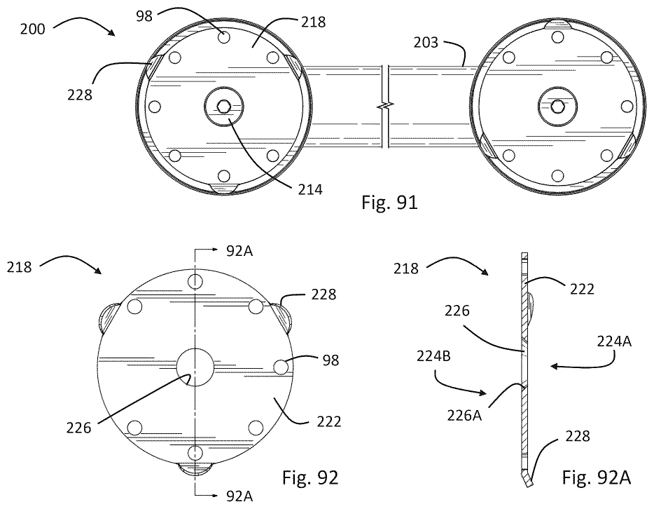

Referring to FIG. 91-92A, wall plate 218 has a wall plate body 222 having a first wall plate face 224A and an opposed second wall plate face 224B, the wall plate body 222 being configured to secure to a wall, such as via one or more fasteners (not pictured) each passing through respective apertures 98. Wall plate body 222 defines central aperture 226, which is configured to receive a fastener, such as screw or bolt 214. Central aperture 226 may have a beveled edge 226A (FIG. 92A) shaped to receive the head of fastener 214. Wall plate 218 may also comprise one or more bumpers 228.

Referring to FIGS. 90, 93, 93A, 95, and 96, mounting post 220 extends between, and is mounted to, handle body 203 and wall plate 218. Mounting post 220 may act to space the handle body 203 from the wall when installed. As such, mounting post 220 will have a suitable length, such as a length great enough to accommodate the fingers of a user's hand when gripping handle body 203. Mounting post 220 may have an outer wall 228 that defines an inner chamber 232. Outer wall 228 may span from a first end 230A to a second end 230B. First end 230A may be shaped to mate or otherwise engage with a complementarily shaped handle body 203. For example, top end 230A may have a suitable shape, such as a flat, fish mouth or arcuate shape, configured to engage with second face 212B of handle body 203, which may have a flat or curved shape. Bottom end 230B may be shaped or configured to mate with wall plate 218. For example, wall plate 218, such as first wall plate face 224A, may define a ridge or groove that abuts and aligns bottom end 230B of mounting post 220. Inner chamber 232 is configured to receive the fastener 214 (FIG. 90). When assembled, fastener 214 extends from central aperture 226, through inner chamber 232, to end cap part 234.

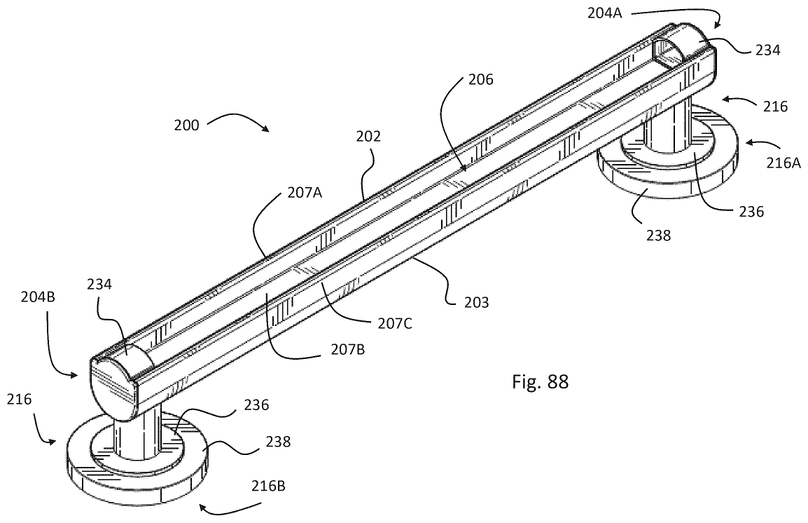

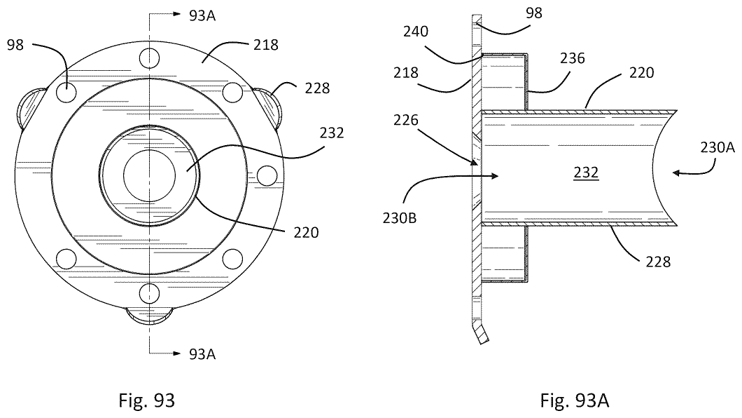

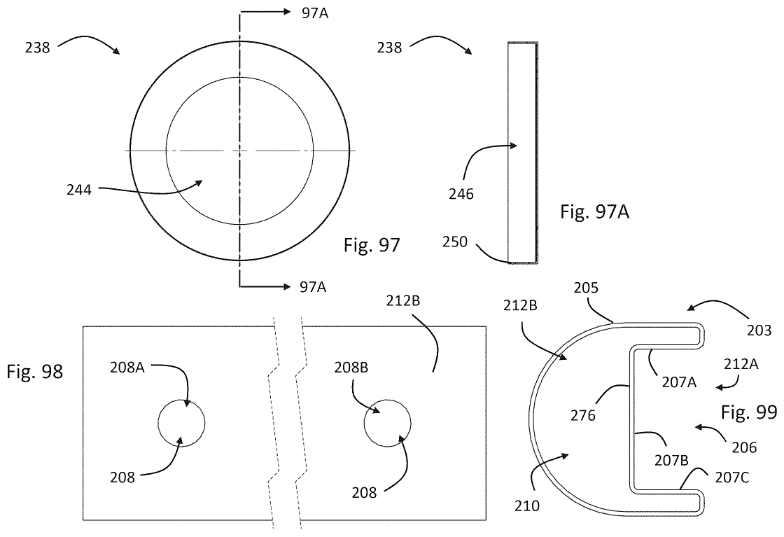

Referring to FIGS. 88, 93, 93A, 94, 94A, 97, and 97A, an inner cover 236 and/or outer cover 238 may be used to cover or shield one or more parts of handle de vice 200, such as wall plate 218. Inner cover 236 may be configured to abut the first wall plate face 224A. For example, edge 240 of inner cover 236 may abut first wall plate face 224A (FIG. 93A). Inner cover 236 may define an inner cover aperture 242 configured for receiving and abuting mounting post 220. Inner cover aperture 242 may be shaped to complement the shape and size of second end 230B of mounting post 220. Inner cover 236 may define an inner cover chamber 248. Outer cover 238 may define an outer cover chamber 246 configured to receive wall plate 218. Edge 250 of outer cover 238 may abut the wall when handle device 200 is installed. Outer cover 238 may define outer cover aperture 244 configured for receiving and abuting inner cover 236. In some embodiments, outer cover aperture 244 is configured for receiving and abuting mounting post 220. In such embodiments, outer cover 238 may cover substantially all of mounting plate 218 and inner cover 236 may not be used.

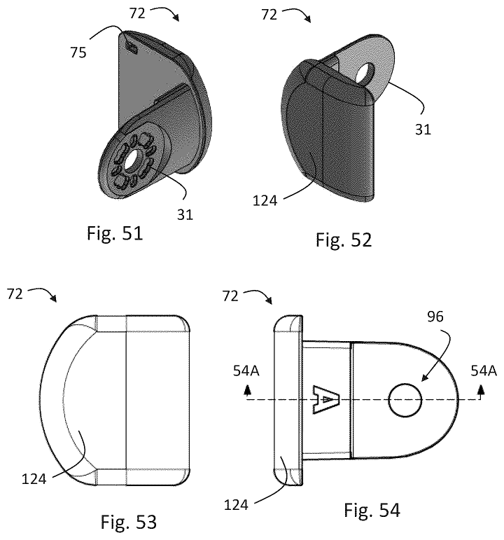

Referring to FIGS. 51-63, end cap 72 may be coupled to handle device 10 to provide flush ends of handle device 10. In embodiments having recesses for receiving inserts, such as recesses 40 and 41 of the handle and connector modules, respectively, end cap 72 provides a wall to close off or provide a boundary for said recesses. End cap 72 may have an abutment member 124 for abutting and capping an end of the modular handle device 10. Abutment member 124 may define alignment recess 75 for receiving alignment tab 74. Although end caps 72 are depicted in the Figures as defining two alignment recesses 74, plural alignment recesses may be present. End cap 72 may have one or more alignment tabs 74 instead or in combination with alignment recesses 75.

End cap 72 may form part of handle module 12. For example, abutment member 124 may form part of handle body 13 or connector body 50. End cap 72 may be continuous with one or more of handle body 13 or connector body 50 or be otherwise fastened, such as by welding or adhesive.

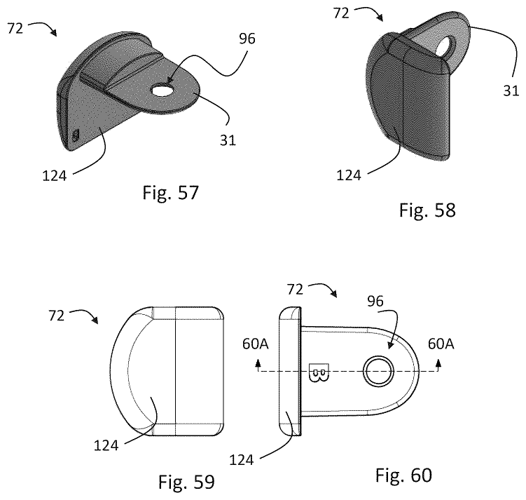

Referring to FIGS. 51-62, end cap 72 may comprise a coupling tab 31 extending from abutment member 124. Coupling tab 31 of end cap 72 may be configured to mate with complimentarily shaped coupling tabs 30 of coupler 22 or end cap 72. For example, coupling tab 31 may have a mating portion 90 having upper shelf 92A (FIG. 57-62) or lower shelf 92B (FIGS. 51-56). Coupling tab 31 may define aperture 96 that can overlap with aperture 35 of complementary coupler 22 when mated and received in channel 56 of connector module 14.

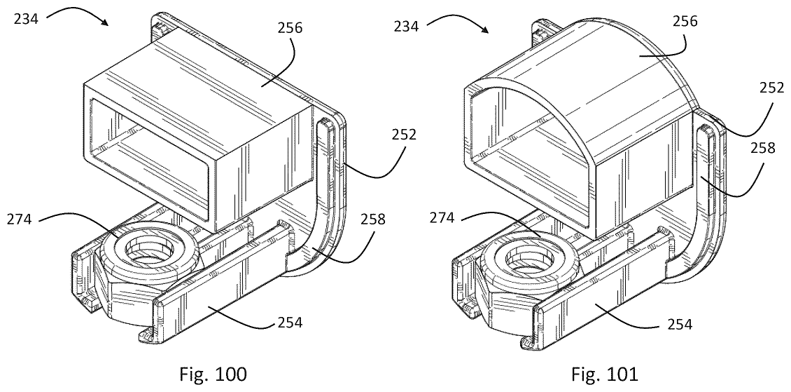

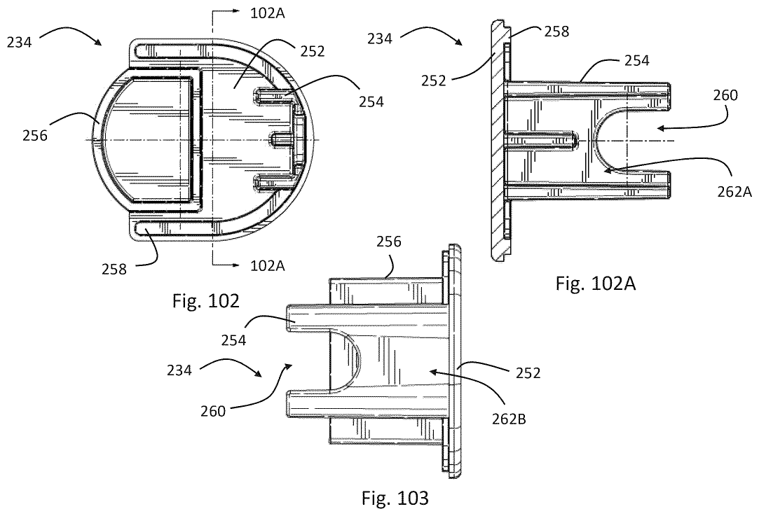

Referring to FIGS. 100-103, end cap part 234 may be used to cap ends 204A and 204B of handle device 200. End cap part 234 may have an abutment member 252 for abutting and capping or otherwise providing a flush surface on first or second ends 204A, 204B of handle body 203. Abutment member 252 may have a raised shelf 258 configured for abuting an inner surface of handle body 203 to provide a snug or friction fit when mated.

End cap part 234 may have an end cap insert 254 extending from abutment member 252. End cap insert 254 may be configured to be inserted within hollow interior 210 of handle body 203. Insert 254 may be configured to abut against an inner surface of hollow interior 210 when installed, for example second surface 262B may be shaped and positioned to abut an inner surface of bottom face 212B of handle body 203. End cap insert 254 may be configured for receiving the fastener 214, for example via slot 260. Slot 260 may be defined by insert 254 such that the fastener fits into slot 260. In some embodiments, fastener 214 abuts an edge of slot 260 when installed. Referring to FIGS. 100 and 101, insert 254 may have a securement member 274, such as a nut as pictured, for receiving and securing part of fastener 214. In some embodiments, the securement member is formed by the insert 254. In such cases, the securement member may be an aperture that secures to the fastener 214 by suitable means, such as complementary threading or an interference fit. In other embodiments, securement member 174 is a nut that abuts part of slot 260. Securement member 274 may be welded or adhered to insert 254. Securement member 174 may be a locknut, such as a nyloc nut.

End cap part 234 may have an end cap extension member 256 extending from abutment member 252. In some cases, extension member 256 and insert 254 extend from the same face of abutment member 252. Extension member 256 may be configured to be inserted and received into at least part of channel 206 when installed into handle body 203. As shown in FIGS. 100 and 101, extension member 256 may have a suitable shape and configuration, such as substantially straight or arcuate in cross-section. Extension member 256 may also be at least partially inserted into an insert placed into recess 206, such as those described herein. The extension member 256 and/or abutment member 252 may be shaped to compliment the shape of the insert, such as a curved or arcuate shape to compliment a curved insert.

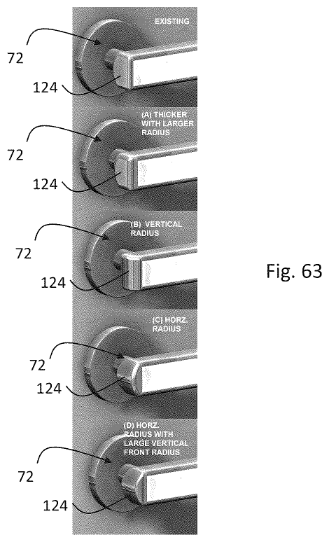

Referring to FIGS. 63, 100, and 101, abutment member 124 may have various shapes and configurations. For example, abutment member may have a flat or arcuate configuration.

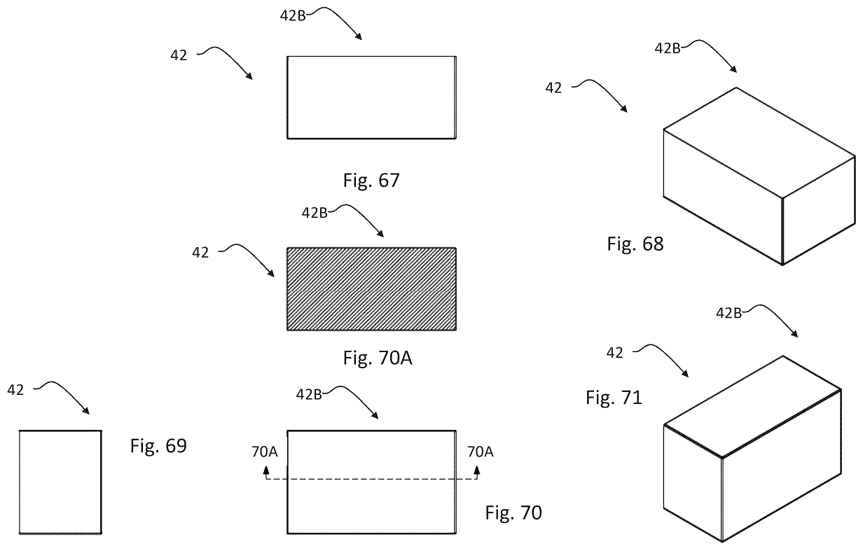

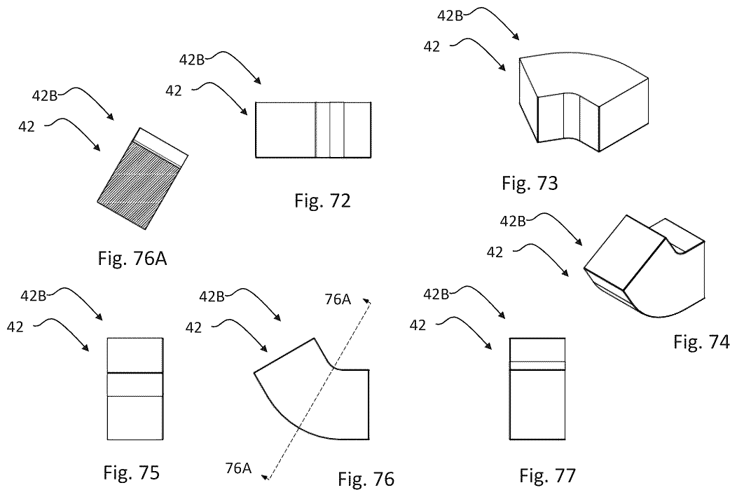

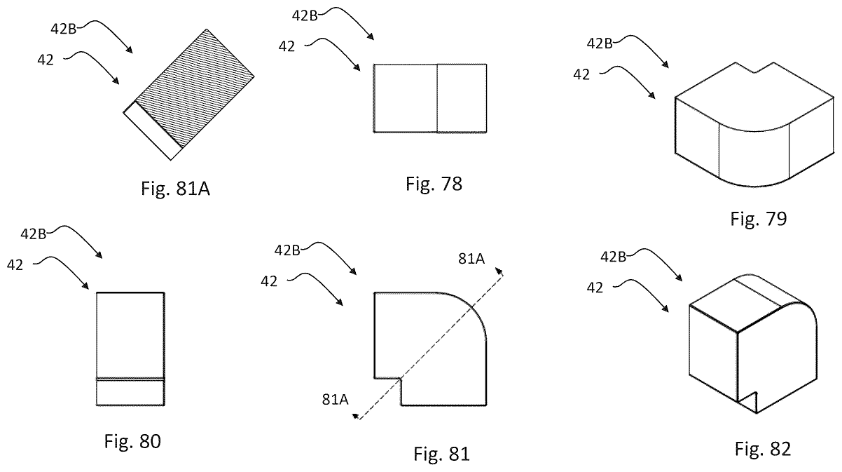

As shown in FIGS. 1-22, one or more of handle module 12 or connector module 14 may be configured to receive/retain an insert 42. Insert 42 may be a solid (or otherwise single piece) insert, such as those shown in FIGS. 67-86A, or it may be formed by a moldable/formable material or process within recess 40. For example, an insert comprising tiles and adhesive may be installed into the recess, such as recess 40 of handle module 12. In cases where insert 42 is one or more continuous pieces, the insert may be removable from its recess. As shown in FIGS. 67-86A, insert 40 may be shaped to be received within recess 40 or recess 41. Insert 42 may comprise a suitable material, such as glass, tile, metal, plastic, wood, or a combination thereof. Insert 42 may have a suitable colour, such as a colour with a high visibility. Insert 42 may be retained within recess 40 or 41 by a suitable means, such as adhesive, welding, fasteners, interference fit, and others.

Referring to FIGS. 64-66, a plate 46 may be inserted into a slot 44 defined in handle module 12. Plate 46 may be used to provide a substantially flat surface for insert 42. Plate 46 may also form part of channel 56. Slot 44 may be defined by handle body 13. Plate 46 may define one or more plate apertures 47 for securing the plate to the handle module 12.

Handle device 10 may consist of a single module, such as handle module 12. In such cases, the handle module 12 may have end caps and wall mounts connected by a suitable method, such as bolting, welding and others described herein and known in the art. Such handle devices 10 may have recesses for receiving inserts 42. For example, single or non-modular handle devices 10 may have handle module 12 defining recess for receiving an insert 42. In such handle devices, handle modules 12, end caps 72, and/or connector modules 14 may be directly connected or be one continuous part. In continuous devices 10 (such as non-modular handle devices), handle module 12 may be a handle part and connector module 14 may be a connector part of the handle device 10.

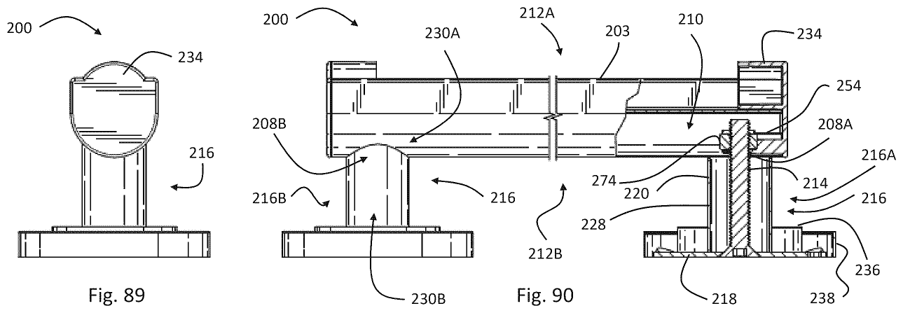

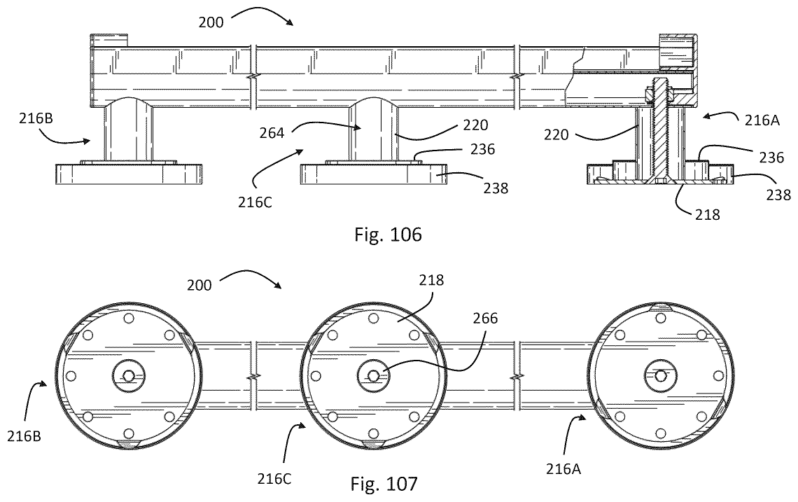

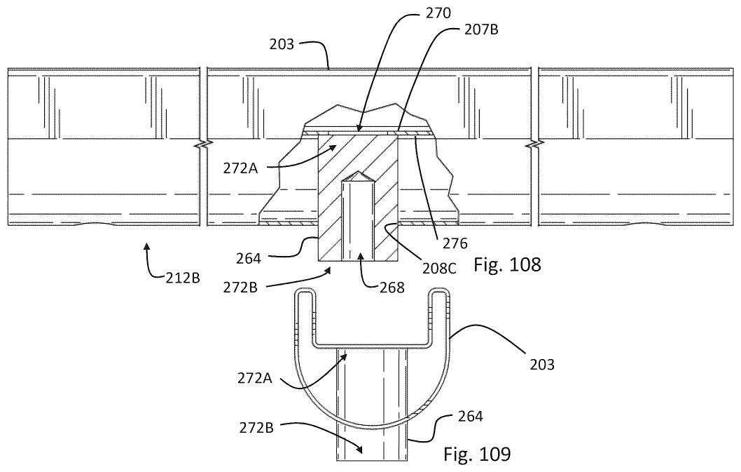

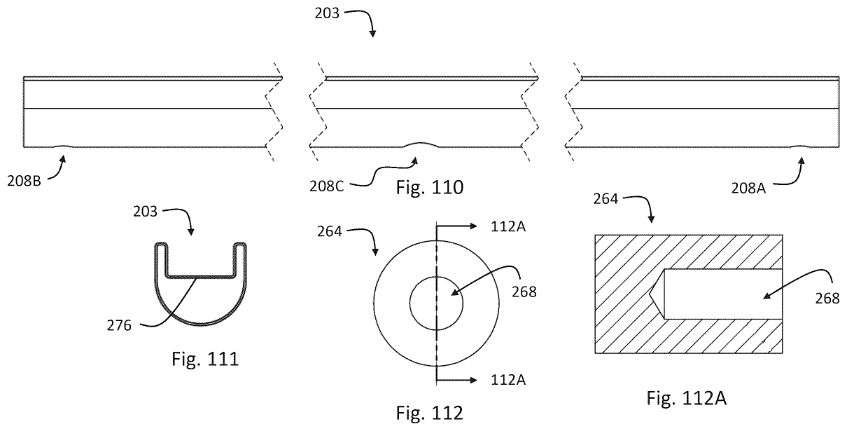

Referring to FIGS. 88-112A, fixed, non-modular handle devices 200 are disclosed herein. Handle device 200 has handle part 202 that is configured to be grasped by a user. Handle part 202 has a first handle end 204A and an opposed second handle end 204B, a top end 212A and a bottom end 212B. A recess 206 is defined by handle body 203 and is configured to receive an insert, such as the inserts described herein. Recess 206 may span fully or partially between first end 204A to second end 204B, and may generally be disposed on first face 212A. For example, recess 206 may span the entirety of handle body 203, such that either end is open. As shown in FIGS. 98 and 99, handle body 203 may have a continuous wall 205 that forms body 203. Recess 206 may be defined by walls 207A, 207B, and 207C. Walls 207A-C may be formed by continuous wall 205. Insert (not pictured) may be retained within recess 206 by a suitable means, such as adhesive, welding, fasteners, interference fit, and others.

Handle body 203 defines at least two apertures 208A and 208B configured for receiving a fastener, such as screw or bolt 214 in FIG. 90. Apertures 208A and 208B may be defined on second face 212B of wall 205. As shown in FIG. 99, body 203 defines hollow interior 210, which may span fully or partially between first end 204A to second end 204B.

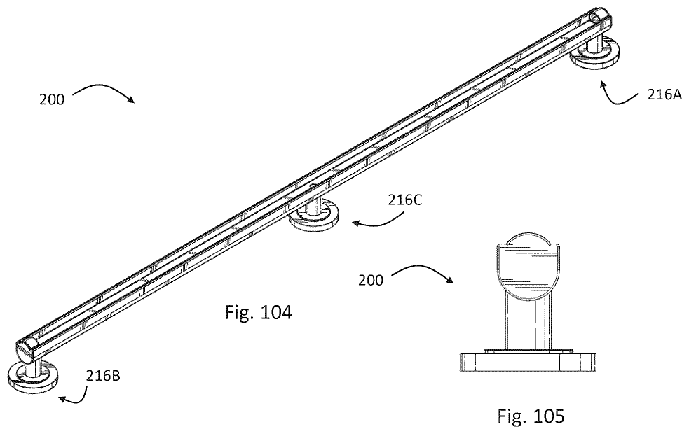

Referring to FIGS. 104-112A, handle device 200 may have more than two wall mounts 216, such as a third wall mount 216C. Third wall mount 216C may have a wall plate 218, a mounting post 220, and an extension member 264. A first end 272A of extension member 264 may be mounted to a surface 276 of wall 207B and extension member 264 may extend into hollow interior 210. A second, opposing end 272B of member 264 protrude from face 212B of handle body 203. Extension member 264 may define a cavity 268 configured to receive a fastener, such as a screw 266. Extension member 264 may being configured to secure to the handle part, for example via one or more fasteners, such as a screw, adhesive, or welding. For example, top end 272A may be welded to the perimeter of aperture 270 of wall 207C. Referring to FIGS. 112 and 112A, channel 268 may define threading that cooperates with complementary threading of the fastener 266. Handle body 203 may define a third aperture 208C for receiving the one or more fasteners to secure extension member 264 to handle body 203. Although the embodiments of FIGS. 104-112A depict handle devices 200 with three wall mounts 216A-C, a person of skill in the art would understand that four or more wall mounts may be used. For example, more wall mounts may be used to increase the stability of longer handle devices 200.

Referring to FIGS. 1, 2 and 87A-N, methods for installing modular handle devices 10 are disclosed herein. The method comprises:
coupling handle module 12 to first connector module 14A and second connector module 14B at first handle end 24A and opposed second handle end 24B, respectively, via a respective first coupler 22A and a second coupler 22B;
securing first wall plate 18A and second wall plates 18B to a surface of a wall;
mounting first extension plate 20A and second extension plate 20B on respective first and second wall plates 18A, 18B;
securing first connector module 14A to first extension plate 20A; and
securing second connector module 14B to second extension plate 20B.

The step of securing first and second wall plates 18A, 18B to the surface of the wall may comprise fastening first and second wall plates 18A, 18B to the surface via at least two fasteners per wall plate. Wall plates 18A, 18B may be installed to a suitable component of the wall, such as a stud or wood board. Wall plates 18A, 18B may also be installed to non-structural wall elements using suitable fasteners. Suitable fasteners may include wall anchors, such as fasteners/wall anchors made by WINGITS®. In some cases, wood boards are first installed into the wall to provide an anchor for wall mounts 16.

First and second extension plates 20A and 20B may be fastened to their respective wall plates 18A, 18B by a suitable method. For example, a set screw may be used. Alternatively, or in combination with, mounting may include engaging threading 105 of each of the first and second extension plates with complementary threading 103 of corresponding first and second wall plates (FIGS. 43-50).

First connector module 14A may be secured to the first coupler 22A, first extension plate 20A and first wall mount 16A via a suitable fastener, such as threaded bolt 70 (FIG. 2). Second connector module 14B may be secured to second coupler 22B, second extension plate 20B, and second wall mount 16B via a suitable fastener.

The step of coupling may include inserting coupler body 28 of each of the first and second couplers 22A, 22B into respective handle coupling channels 26A, 26B. Coupling may comprise inserting respective coupling tabs 30 extending from the coupler body 28, into respective connector coupling channels 56A, 56B defined by respective first and second ends 54A, 54B of the connector module 14.

Prior to inserting coupler bodies 28 into channels 26 of handle module 12, plate 46 may be inserted into slot 44. Plate 46 may be secured to handle module 12 via fasteners 134 through apertures 47. A fastener, such as an adhesive strip, may be applied to a surface, such as outward facing surface 45, of plate 46 to retain insert 42.

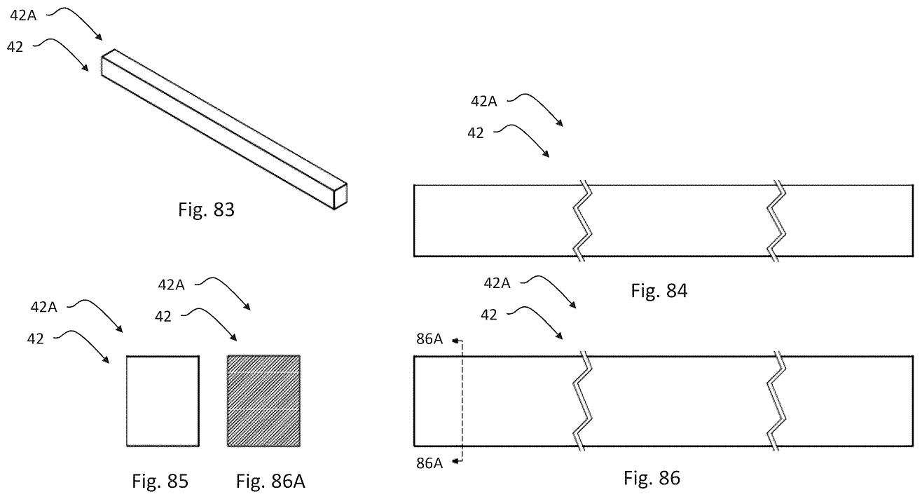

Inserts 42 may also be inserted into handle device 10. For example, the methods may include inserting a handle insert 42A (FIGS. 83-86) into a recess 40 defined by the handle module 12, and/or inserting a connector insert 42B into a recess 41 defined by the connector module 14 (FIGS. 67-82).

Although the steps of the method are presented in an order, it will be understood the order of the steps of the methods may be varied. For example, extension plate 20 may be installed to handle device 10 via connecting module 14 prior to installing to wall plate 18. After extension plate 20 and bar 10 are mounted to wall plate 18, a fastener, such as a set screw, may be installed through aperture 110 to secure extension plate 20 to wall plate 18.

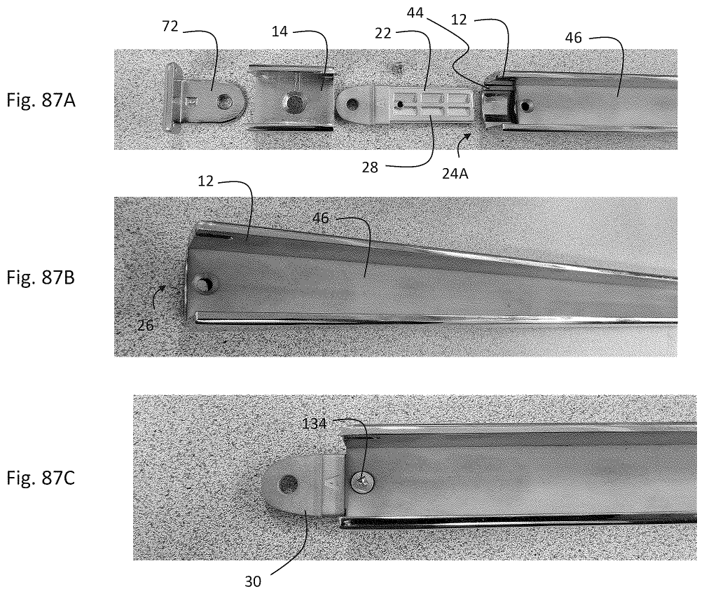

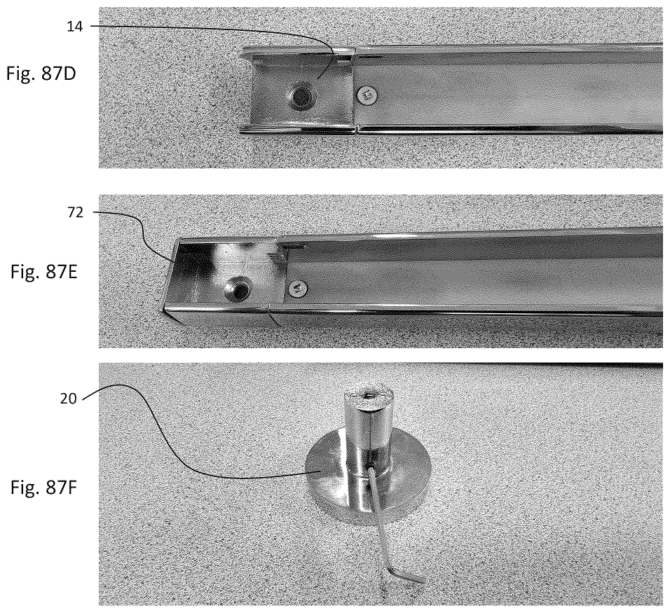

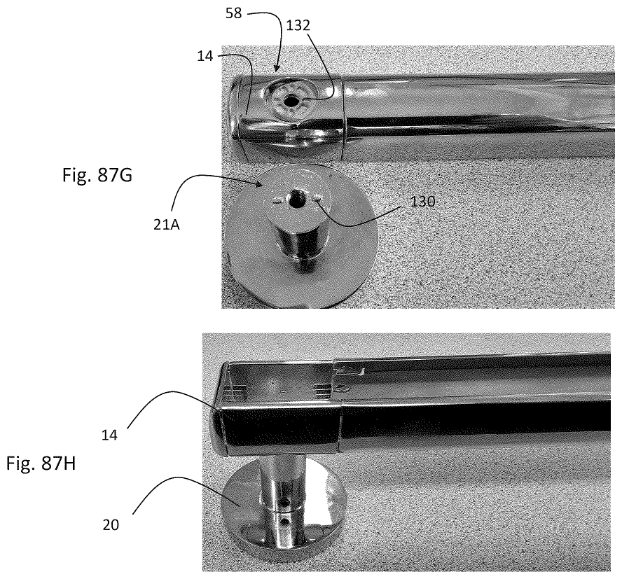

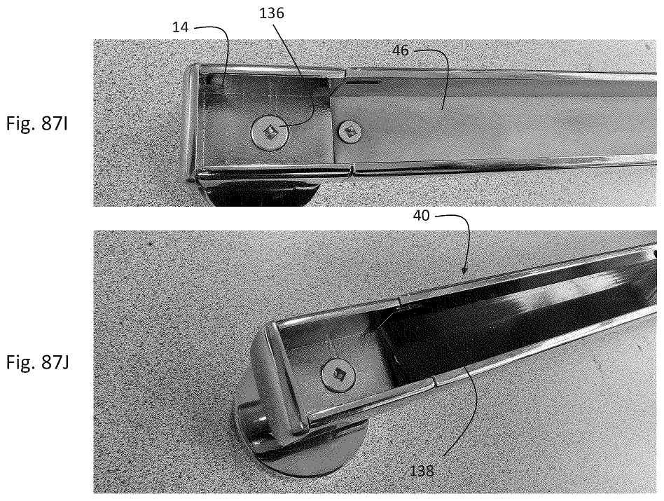

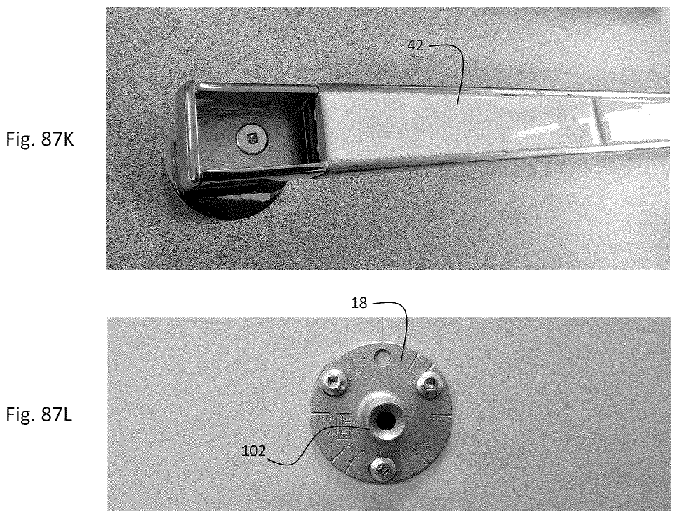

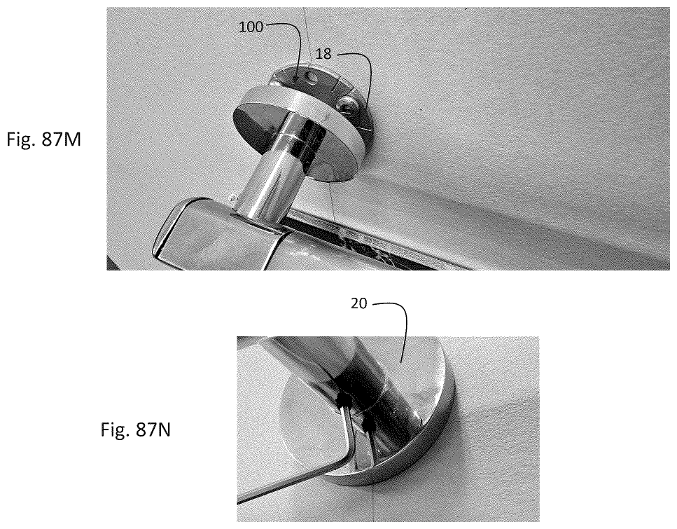

Referring to FIGS. 87A-N, an example of a method of assembling handle device 10 is depicted. A user may start by coupling connector module 14 to an end of handle module 12, such as 24A (FIG. 87A). Coupling connector module 14 may include inserting plate 46 into slot 44 and securing to handle module 12 via a fastener 134, such as a screw, through aperture 47 (FIG. 87B-C). Coupler body 28 may then be inserted into channel 26 such that coupler tab 30 is protruding from end 24A (FIG. 87C). Coupler tab 30 may then be inserted into channel 56 of connector module 14 (FIG. 87D). Coupler tab 30 of either end cap 72 (FIG. 87E) or another coupler 22 may then be inserted into channel 56. A set screw may then be partially screwed into aperture 110 of extension plate 20 (FIG. 87F). As shown in FIG. 87G, first end 21A of extension plate 20 may be inserted into aperture 58. Guide pins 130 may be inserted into recesses 132 of coupler 22 or end cap 72 (FIG. 87G-H). A fastener 136, such as a screw, may be threaded through apertures in connector module 14, coupler 22, end cap 72 and extension plate 20 to connect connector module 14, coupler 22, end cap 72 and extension plate 20 (FIG. 871). A fastener, such as an adhesive strip 138, may be applied to plate 46 to retain insert 42 (FIG. 87J). Filler strips to raise a height of the base plate and make recess 40 more shallow may be used. Insert 42 may then be inserted (87K). A suitable adhesive, such as Tile Adhesive, Construction Adhesive, and others, may be used to install insert 42. In some cases, insert 42 is a solid piece that is inserted and adhered to handle module 12. Wall plate 18 may then be secured to a wall via two or more fasteners (such as three wall screws), as shown in FIG. 87L. In some cases, wall anchors such as those sold by WINGITS® are used. Wall plate 18 and male part 102 may then be placed within chamber 100 of extension plate 20 (FIG. 87M). The extension plate 20 and handle device 10 may then be secured/mounted to the wall through wall plate 18 via a suitable fastener, such as a set screw (FIG. 87N).

Referring to FIG. 90, an example of a method of installing handle device 200 is described herein. End cap part 234 with securement member 274 may be secured to ends 204A or 205B by a suitable means, such as an interference fit between raised shelf 258 and an inner surface of hollow interior 210. Edge 240 of inner cover 236 may be welded to wall plate 218. Outer cover 238 may be movably placed such that mounting post 220 is within aperture 244. Second end 230B of mounting post 220 may be placed within aperture 242 of inner cover 236. Fastener 214 is then threaded through central aperture 226, through the inner chamber of mounting post 220 into hollow interior 210. The fastener 214 is then threaded to securement member 274, thus securing wall plate 218, inner cover 236, mounting post 220, end cap part 234 and handle body 203 together. Once each wall mount 216 is secured via fastener 214, the handle device 200 may be installed to a wall. For example, the movably placed outer cover 238 may be moved to expose apertures 98 of wall plate 218. One or more fasteners (not pictured) may then be used to secure the wall plate, and handle device 200, to the wall. Once the handle device 200 has been mounted to the wall, outer cover 238 may be placed around an outer perimeter of wall plate 218 such that edge 240 is abuting the wall surface. Bumpers 228 may abut against outer cover 238 such that a friction or interference fit prevents the cover from moving easily relative to the plate 218.

Modules of handle devices 10 and 200 are manufactured by a suitable process, such as cast die, progressive die, crushing pipe or others. A combination of processes may be used. For example, some modules, such as connector module 14, may be made by a cast die process and other modules, such as handle module 12, are made by a progressive die process. A progressive die system may start with flat stock and progressively curving the flat stock into the desired shape. Other features may then be machined, such as coupling channels 26A and 26B. Another suitable manufacturing process includes face cutting of a stainless tube/pipe. In such cases, a stainless steel pipe would have about ⅓ of its face removed. The pipe may then look like a wide open “C”. This may provide for a cavity where appropriately shaped inserts 42 would be secured in place. Crushed pipe manufacturing techniques may include crushing or pressing a pipe into a suitable shape, such as a “U” shape for handle module 12, resulting in a cavity within which inserts 42 could be mounted. Such processes could be used to manufacture one or more parts of handle device 200, such as handle body 203. In some cases, the handle body 203 is formed by extrusion or bending of a stainless steel pipe. The extruded handle body may be subject to further modifications after extruded or bent, such as drilling apertures 208.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Terms of orientation used herein, such as “top,” “bottom,” “horizontal,” “vertical,” “longitudinal,” “lateral,” and “end” are used in the context of the illustrated embodiment. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular” or “cylindrical” or “semi-circular” or “semi cylindrical” or “arcuate” or any related or similar terms, are not required to conform strictly to the mathematical definitions of circles or cylinders or other structures, but can encompass structures that are reasonably close approximations.

The terms “approximately,” “about,” and “substantially” as used herein represent an amount close to the stated amount that still performs a desired function or achieves a desired result. For example, in some embodiments, as the context may permit, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic. As an example, in certain embodiments, as the context may permit, the term “generally parallel” can refer to something that departs from exactly parallel by less than or equal to 20 degrees.

Although the devices, assemblies, and/or methods have been disclosed in the context of certain embodiments and examples, the scope of this disclosure extends beyond the specifically disclosed embodiments to other alternative embodiments and/or uses of the embodiments and certain modifications and equivalents thereof. Various features and aspects of the disclosed embodiments can be combined with or substituted for one another in order to form varying modes of the conveyor. The scope of this disclosure should not be limited by the particular disclosed embodiments described herein.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while operations may be depicted in the drawings or described in the specification in a particular order, such operations need not be performed in the particular order shown or in sequential order, and all operations need not be performed, to achieve the desirable results. Other operations that are not depicted or described can be incorporated in the example methods and processes. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations. The described components and systems can generally be integrated together in a single product or packaged into multiple products. Additionally, other implementations are within the scope of this disclosure.

Some embodiments have been described in connection with the accompanying drawings. The figures are drawn to scale where appropriate, but such scale should not be interpreted as limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

In summary, various embodiments and examples of handle devices, handle assemblies, systems, and/or methods have been disclosed. This disclosure expressly contemplates that various features and aspects of the disclosed embodiments can be combined with, or substituted for, one another. Accordingly, the scope of this disclosure should not be limited by the particular disclosed embodiments and examples described above, but should be determined only by a fair reading of the claims that follow.

All citations are hereby incorporated by reference. In the event of conflicting information with statements between any reference to or incorporated herein, and the present disclosure, the present disclosure will act as the guiding authority.

What has been described is merely illustrative of the application of the principles of the disclosure. However, it will be apparent to a person skilled in the art that a number of variations and modifications can be made without departing from the scope of the following claims.

What is claimed is:

1. A modular handle device comprising:
a handle module comprising:
a handle body having a first handle end and an opposed second handle end, the handle body being configured to be grasped by a user;
at least two connector modules, each individually coupled to respective handle ends via a respective coupler, each connector module comprising:
a connector body with a first connector face and an opposing second connector face, each connector face spanning between a first connector end and an opposed second connector end; and
at least two wall mounts, each extending from corresponding connector modules, each wall mount being configured to secure the modular handle device to a surface of a wall.

2. The modular handle device of claim 1, wherein the wall mount comprises:
a wall plate comprising:
a wall plate body having a first wall plate face and an opposed second wall plate face, the wall plate body being configured to secure to a wall;
a male part extending from the first wall plate face;

3. The modular handle device of claim 2, wherein the wall mount comprises:
an extension plate comprising:
an extension plate body having a first extension plate face and an opposed second extension plate face;
the second extension plate face defining a chamber configured to receive the wall plate; and
a female part extending from the first extension plate face having an inner chamber configured to mate with the male part of the wall plate.

4. The modular handle device of claim 3, wherein an outer surface of the male part of the wall plate and an inner surface of the female part have complementary threading.

5. The modular handle device of claim 1, wherein the second connector face defines a wall mount aperture configured to receive the wall mount.

6. The modular handle device of claim 1, further comprising an alignment tab shaped and positioned to be received by a corresponding alignment recess when a handle module and connector module are coupled.

7. The modular handle device of claim 6, wherein the alignment tab is extending from the first connector end and/or the second connector end, and the alignment recess is defined in the first handle end and/or second handle end.

8. The modular handle device of claim 7, wherein the first handle end defines at least one alignment recess, the second handle end defines at least one alignment recess, at least one alignment tab extends from the first connector end, and at least one alignment tab extends from the second connector end.

9. The modular handle device claim 1, wherein the first handle end and second handle end each define a respective handle coupling channel.

10. The modular handle device of claim 9, wherein the first connector end and the second connector end each define a connector coupling channel.

11. The modular handle device of claim 10, wherein the connector coupling channel continuously spans from the first connector end to the second connector end.

12. The modular handle device of claim 10, wherein each coupler comprises:
a coupler body configured to be received in the handle coupling channel; and
a coupling tab extending from an end of the coupler body, the coupling tab being configured to be received in the connector coupling channel.

13. The modular handle device of claim 12, wherein the coupling tab is configured for mating with an adjacent coupling tab.

14. The modular handle device of claim 13, wherein the coupling tab has one of:
an upper shelf; or
a lower shelf;
wherein the upper shelf and lower shelf are configured to mate with one another.

15. The modular handle device of claim 14, wherein the upper shelf and lower shelf form a pivot point when mated and connected to one another via a fastener.

16. The modular handle device of claim 8, wherein the coupler comprises a tongue configured to slidably engage a corresponding groove defined within the handle coupling channel.

17. The modular handle device of claim 1, wherein the handle module defines a recess configured for receiving an insert.

18. The modular handle device of claim 1, further comprising an end cap module comprising:
an abutment member for abutting and capping an end of the modular handle device;
an end cap coupling tab extending from the abutment member, the end cap coupling tab being configured to be received in the connector coupling channel.

19. A handle device comprising:
a handle part comprising:
a handle body having a first handle end and an opposed second handle end;
the handle body defining a recess for receiving an insert;
the handle body defining a first and second aperture for receiving a fastener;
the handle body defining a hollow interior;
the handle body being configured to be grasped by a user;
first and second wall mounts, each extending from the handle part, each wall mount being configured to secure the handle device to a surface of a wall, each of the first and second wall mounts comprising:
a wall plate comprising:
a wall plate body having a first wall plate face and an opposed second wall plate face, the wall plate body being configured to secure to a wall;
a central aperture defined by the wall plate body and configured to receive a fastener;
a mounting post extending between and mounted to the handle part and the wall plate, the mounting post defining an inner chamber configured to receive the fastener; and
an end cap part comprising:
an abutment member for abutting and capping the first or second end of the handle part; and
an end cap insert extending from the abutment member, the end cap insert being configured to be inserted within the hollow interior of the handle body, the end cap insert being configured for receiving the fastener;
wherein the fastener spans from the central aperture, through the inner chamber of the mounting post to the slot, when assembled.

20. The handle device of claim 19, further comprising a third wall mount, the third wall mount comprising:
a wall plate comprising:
a wall plate body having a first wall plate face and an opposed second wall plate face, the wall plate body being configured to secure to a wall;
a central aperture defined by the wall plate body and configured to receive a fastener;
an extension member extending from, and mounted to, the hollow interior of the handle body, the extension member defining a cavity configured for receiving a fastener;
a mounting post extending between and mounted to the handle part and the wall plate, the mounting post defining an inner chamber configured to receive the fastener and the extension member; and
wherein the fastener spans from the central aperture, through the mounting post, to the cavity of the extension member when assembled.
